(19) United States
(12) Patent Application Publication
(10) Pub. No.: US 2025/0035802 A1
(43) Pub. Date: Jan. 30, 2025

(54) METHODS AND SYSTEMS FOR IMPROVING GENERALIZATION AND PERFORMANCE OF SEISMIC MACHINE-LEARNED MODELS THROUGH IN-DOMAIN ADVERSARIAL ATTACKS

(71) Applicant: SAUDI ARABIAN OIL COMPANY, Dhahran (SA)

(72) Inventors: Salma AlSinan, Dhahran (SA); Ali Aldawood, Safwa (SA); Maksim Makarenko, Dhahran (SA); Sixiu Liu, Dhahran (SA)

(73) Assignee: SAUDI ARABIAN OIL COMPANY, Dhahran (SA)

(21) Appl. No.: 18/361,452

(22) Filed: Jul. 28, 2023

(51) Int. Cl. E21B 7/04; E21B 44/00; G01V 1/28

(52) U.S. Cl. CPC G01V 1/282; E21B 7/04; G01V 2210/30; G01V 2210/66

(57) ABSTRACT

A method for performing a seismic processing task using a machine-learned model developed using an in-domain adversarial attacker. The method includes obtaining a machine-learned model parameterized by a set of weights and generating a synthetic seismic dataset and associated target. The method further includes determining a noise profile for the synthetic seismic dataset in a frequency domain that when added, in a spatial-temporal domain, to the synthetic seismic dataset reduces a performance of the machine-learned model. The method further includes adding the noise profile to the synthetic seismic dataset forming a noisy seismic dataset and updating the set of weights of the machine-learned model based on the noisy seismic dataset and the target. The method further includes receiving a seismic dataset corresponding to a subsurface, processing the seismic dataset with the machine-learned model to form a predicted target, and developing a geological model for the subsurface using the predicted target.

### BACKGROUND

In the context of oil and gas exploration and production, a variety of tools and methods are employed to model subsurface regions and plan wellbore paths to extract desired hydrocarbons. To understand and model a subsurface region of interest, seismic experiments and/or surveys are often conducted. In a seismic survey, energy is emitted from a source into the subsurface region of interest. The emitted energy propagates as a wavefield through the subsurface region of interest and a portion of the propagating energy is reflected at geological interfaces joining portions of the subsurface with differing lithostratigraphic properties (i.e., regions of different rock types). Eventually, reflected wavefields return to the surface of the Earth and the amplitudes of these wavefields are recorded with respect to time by one or more seismic receivers. The collection of recorded amplitudes in time over one or more seismic receivers may be considered a seismic dataset.

A seismic dataset contains information about subsurface reflectors, or geological interfaces, indicating changes in acoustic properties that usually coincide with changes in lithology in the subsurface region of interest. Although a seismic dataset is influenced by the geological structures within the subsurface it does not directly identify what those structures are. For example, the seismic dataset may show a continuous band or surface of high amplitude reflection extending across the 3D grid of points and additional step is required to identify or label that band or surface as a geological boundary or interface separating different types of rocks (“geological formations”). This step, of identifying the geological structures by associated to observed features in a seismic dataset is called seismic interpretation. In general, seismic interpretation may consist of one or more seismic processing tasks, such as first break picking, denoising, fault detection, and determining the velocity of a wavefield through portions of the subsurface. The result of one or more seismic processing tasks may be a 2D or 3D model of the geology within the subsurface. Such a model may typically be called a “geological model.” Geological models may be used, among other things, to identify the location of a hydrocarbon reservoir, plan a wellbore path when drilling a well, and inform reservoir simulators for hydrocarbon production estimation and oil and gas field planning.

In many scenarios, seismic processing tasks are performed, or otherwise implemented, using one or more machine-learned models trained to conduct the given task(s). Typically, training a machine-learned model to perform a seismic processing task requires a large amount of training data. Often, a sufficient quantity of training examples is not available and machine-learned models for seismic processing tasks are trained using synthetically generated training data. While the use of synthetically generated training data may provide a sufficient amount of training examples (in terms of training a machine-learned model to a predefined performance threshold relative to the training data), machine-learned models trained using synthetically generated training data do not typically generalize well to “real” or non-synthetic seismic datasets. For example, real seismic datasets may be contaminated by noise. Accordingly, there exists a need to adjust synthetically generated seismic datasets such that machine-learned models trained using these datasets are robust and capable of generalizing to real seismic datasets.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method that includes obtaining a machine-learned model parameterized by a set of weights and generating a first synthetic seismic dataset and associated first target. The method further includes determining a first noise profile for the first synthetic seismic dataset in a frequency domain that when added, in a spatial-temporal domain, to the first synthetic seismic dataset reduces a performance of the machine-learned model and adding the first noise profile to the first synthetic seismic dataset in the spatial-temporal domain forming a first noisy seismic dataset. The method further includes updating the set of weights of the machine-learned model based on the first noisy seismic dataset and the first target. The method further includes receiving a seismic dataset corresponding to a subsurface, processing the seismic dataset with the machine-learned model parameterized by the updated set of weights to form a predicted target for the seismic dataset, and developing a geological model for the subsurface using the predicted target.

Embodiments disclosed herein generally relate to a system that includes a machine-learned model parameterized by a set of weights, a conventional noise generator that produces an initial noise profile, an in-domain adversarial attacker configured by an in-domain regularizer that updates the initial noise profile to reduce a performance of the machine-learned model, and a computer with one or more computer processors and a non-transitory computer-readable medium. The computer is configured to generate a first synthetic seismic dataset and associated first target, determine a first noise profile using the in-domain adversarial attacker by updating the initial noise profile, and add the first noise profile to the first synthetic seismic dataset in a spatial-temporal domain forming a first noisy seismic dataset. The computer is further configured to update the set of weights of the machine-learned model based on the first noisy seismic dataset and the first target. The computer is further configured to receive a seismic dataset corresponding to a subsurface, process the seismic dataset with the machine-learned model parameterized by the updated set of weights to form a predicted target for the seismic dataset, and develop a geological model for the subsurface using the predicted target.

Embodiments disclosed herein generally relate to a non-transitory computer readable medium storing instructions executable by a computer processor, the instructions including functionality for obtaining a machine-learned model parameterized by a set of weights and generating a first synthetic seismic dataset and associated first target. The instructions further include functionality for determining a first noise profile for the first synthetic seismic dataset in a frequency domain that when added, in a spatial-temporal domain, to the first synthetic seismic dataset reduces a performance of the machine-learned model and adding the first noise profile to the first synthetic seismic dataset in the spatial-temporal domain forming a first noisy seismic dataset. The instructions further include functionality for updating the set of weights of the machine-learned model based on the first noisy seismic dataset and the first target. The instructions further include functionality for receiving a seismic dataset corresponding to a subsurface, processing the seismic dataset with the machine-learned model with an updated set of weights to form a predicted target for the seismic dataset, and developing a geological model for the subsurface using the predicted target.

Other aspects and advantages of the claimed subject matter will be apparent from the following description and the appended claims.

### BRIEF DESCRIPTION OF DRAWINGS

FIG. 1 depicts a system in accordance with one or more embodiments.

FIG. 2 depicts a seismic survey in accordance with one or more embodiments.

FIG. 3 depicts a drill bit seismic survey in accordance with one or more embodiments.

FIG. 4 depicts a neural network in accordance with one or more embodiments.

FIG. 5 depicts a flowchart in accordance with one or more embodiments.

FIG. 6 depicts a conventional training process in accordance with one or more embodiments.

FIG. 7 depicts a data augmentation process in accordance with one or more embodiments.

FIG. 8 depicts various noise profiles of varying strength (or signal-to-noise ratios) applied to a synthetic seismic dataset in accordance with one or more embodiments.

FIG. 9 depicts the frequency spectrum of a field-acquired or real seismic dataset and a synthetically generated seismic dataset with noise added with a conventional noise generator in accordance with one or more embodiments.

FIG. 10 depicts a general adversarial process in accordance with one or more embodiments.

FIG. 11 depicts the tabulated results of two machine-learned models applied to a seismic processing task in accordance with one or more embodiments.

FIG. 12 depicts the tabulated results of two machine-learned models applied to a seismic processing task in accordance with one or more embodiments.

FIG. 13 depicts noise profiles generated using an adversarial attacker in accordance with one or more embodiments.

FIG. 14 depicts a noise complexity vs. noise amplitude plot in accordance with one or more embodiments.

FIG. 15 depicts a noise attack system in accordance with one or more embodiments.

FIG. 16 depicts various noise profiles developed using an in-domain noise adversarial attacker in accordance with one or more embodiments.

FIG. 17 depicts the tabulated results of two machine-learned models applied to a seismic processing task in accordance with one or more embodiments.

FIG. 18 depicts the results of machine-learned models applied to a seismic processing task in accordance with one or more embodiments.

FIG. 19 depicts the results of machine-learned models applied to a seismic processing task in accordance with one or more embodiments.

FIG. 20 depicts the results of two machine-learned models applied to field data for a seismic processing task in accordance with one or more embodiments.

FIG. 21 depicts the results of two machine-learned models applied to field data for a seismic processing task in accordance with one or more embodiments.

FIG. 22 depicts the results of two machine-learned models applied to field data for a seismic processing task in accordance with one or more embodiments.

FIG. 23 depicts a flowchart in accordance with one or more embodiments.

FIG. 24 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

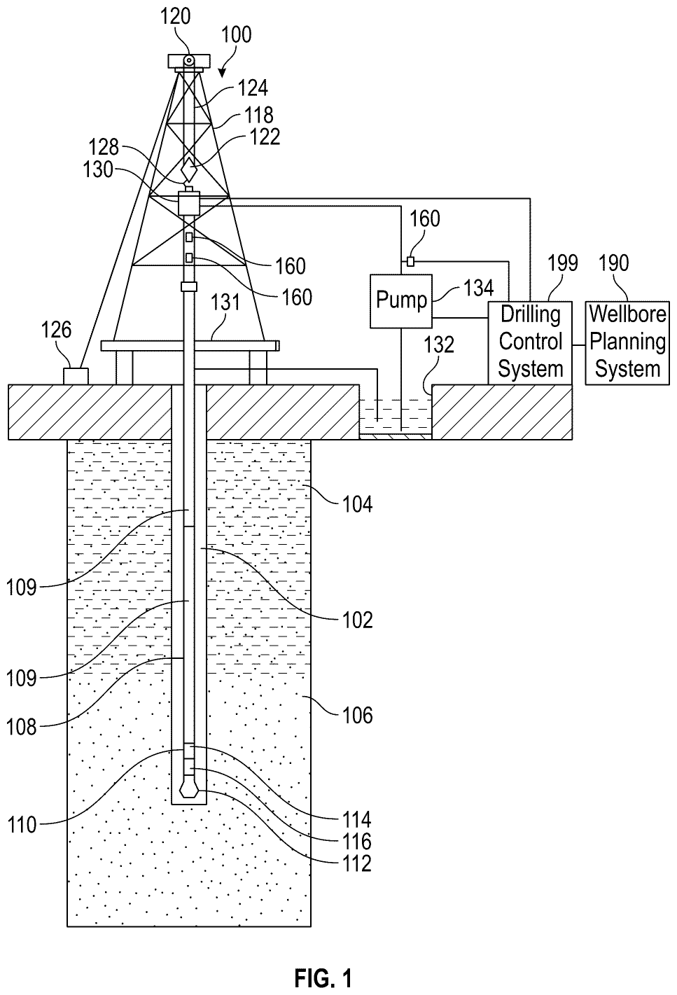

In the following description of FIGS. 1-24, any component described with regard to a figure, in various embodiments disclosed herein, may be equivalent to one or more like-named components described with regard to any other figure (even when distinct numerical labels are employed). For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Processing seismic datasets is an important step in the search for hydrocarbon reservoirs beneath the surface of the earth, planning wellbore path and guiding a drill while drilling a well, and in deciding how best to produce oil and gas from the reservoirs. Interpretation of a seismic dataset through one or more seismic processing tasks includes identifying the geological structures and characteristics that are causing observable features in the seismic dataset and may include building geological models, i.e., 2D or 3D representations of the subsurface. Such structures and characteristics may include, without limitation, boundaries between geological (rock) layers, faults and fractures, facies (i.e., rock type categories), and interfaces between pore fluids.

In many scenarios, seismic processing tasks are performed, or otherwise implemented, using one or more machine-learned models trained to conduct the given task(s). Typically, machine-learned models for seismic processing tasks are trained using real (e.g., historically acquired) and/or synthetically generated training data. However, often, machine-learned models for seismic processing tasks do not generalize well to newly acquired real, or field-acquired (i.e., non-synthetic), seismic datasets. That is, in many instances, machine-learned models for seismic processing tasks tend to underperform in practice—or while used in a production setting—compared to their measured performance during training and validation. For example, real seismic datasets may be contaminated by noise. Origins of noise may include, but are not limited to: the reception of signals (e.g., wavefields) generated by nearby equipment, excluding a seismic source; receiver, or measurement device, uncertainties; and poor receiver couplings (e.g., geophone embedded in the surface). Embodiments disclosed herein relate to a noise attack system that adds and alters noise to synthetic seismic datasets in an adversarial manner to improve the generalization of machine-learned models for seismic processing tasks. As will be shown, the noise attack system may be applied to previously trained models, defined herein as “pre-trained” models, or may be implemented as part of a training procedure.

FIG. 1 depicts a simplified well site (100). In general, well sites may be configured in a myriad of ways. Therefore, the illustrated well site (100) of FIG. 1 is not intended to be limiting with respect to the particular configuration of the drilling equipment. The well site (100) is depicted as being on land. In other examples, the well site (100) may be offshore, and drilling may be carried out with or without use of a marine riser. A drilling operation at well site (100) may include drilling a wellbore (102) into a subsurface including various formations (104, 106). The wellbore (102) may include a bored hole that extends from the surface into a target zone of the subsurface formations (104, 106), such as a reservoir. The subsurface formations (104, 106) may be categorized by various formation properties of interest, such as formation porosity, formation permeability, resistivity, density, water saturation, total organic content and the like. Properties of the subsurface formations (104, 106) may vary spatially.

For the purpose of drilling a new section of wellbore (102), a drill string (108) is suspended within the wellbore (102). The drill string (108) may include one or more drill pipes (109) connected to form conduit and a bottom hole assembly (BHA) (110) disposed at the distal end of the conduit. The BHA (110) may include a drill bit (112) to cut into the subsurface rock. The BHA (110) may include measurement tools, such as a measurement-while-drilling (MWD) tool (114) and logging-while-drilling (LWD) tool (116). Measurement tools (114, 116) may include sensors and hardware to measure downhole drilling parameters, and these measurements may be transmitted to the surface using any suitable telemetry system known in the art. By means of example, a LWD tool (116) commonly collects information about the properties of the subsurface formations (104, 106). As previously described, these may include, but are not limited to, the density, the porosity, and the resistivity of the subsurface formations (104, 106). The BHA (110) and the drill string (108) may include other drilling tools known in the art but not specifically shown.

The drill string (108) may be suspended in a wellbore (102) by a derrick (118). A crown block (120) may be mounted at the top of the derrick (118), and a traveling block (122) may hang down from the crown block (120) by means of a cable or drilling line (124). One end of the cable (124) may be connected to a draw works (126), which is a reeling device that may be used to adjust the length of the cable (124) so that the traveling block (122) may move up or down the derrick (118). The traveling block (122) may include a hook (128) on which a top drive (130) is supported.

The top drive (130) is coupled to the top of the drill string (108) and is operable to rotate the drill string (108). Alternatively, the drill string (108) may be rotated by means of a rotary table (not shown) on the drilling floor (131). Drilling fluid (commonly called mud) may be stored in a mud pit (132), and at least one pump (134) may pump the mud from the mud pit (132) into the drill string (108). The mud may flow into the drill string (108) through appropriate flow paths in the top drive (130) (or a rotary swivel if a rotary table is used instead of a top drive to rotate the drill string (108)).

In one implementation, a drilling control system (199) may be disposed at or communicate with the well site (100). Drilling control system (199) may control at least a portion of a drilling operation at the well site (100) by providing controls to various components of the drilling operation. In one or more embodiments, the drilling control system (199) may receive data from one or more sensors (160) arranged to measure controllable parameters of the drilling operation. As a nonlimiting example, sensors (160) may be arranged to measure WOB (weight on bit), RPM (drill string rotational speed), GPM (flow rate of the mud pumps), and ROP (rate of penetration of the drilling operation).

Sensors (160) may be positioned to measure parameter(s) related to the rotation of the drill string (108), parameter(s) related to travel of the traveling block (122), which may be used to determine ROP of the drilling operation, and parameter(s) related to flow rate of the pump (134). For illustration purposes, sensors (160) are shown on drill string (108) and proximate mud pump (134). The illustrated locations of sensors (160) are not intended to be limiting, and sensors (160) could be disposed wherever drilling parameters need to be measured. Moreover, there may be many more sensors (160) than shown in FIG. 1 to measure various other parameters of the drilling operation. Each sensor (160) may be configured to measure a desired quantity.

During a drilling operation at the well site (100), the drill string (108) is rotated relative to the wellbore (102), and weight is applied to the drill bit (112) to enable the drill bit (112) to break rock as the drill string (108) is rotated. In some cases, the drill bit (112) may be rotated independently with a drilling motor (not shown). In other embodiments, the drill bit (112) may be rotated using a combination of the drilling motor and the top drive (130) (or a rotary swivel if a rotary table is used instead of a top drive to rotate the drill string (108)). While cutting rock with the drill bit (112), mud is pumped into the drill string (108).

The mud flows down the drill string (108) and exits into the bottom of the wellbore (102) through nozzles in the drill bit (112). The mud in the wellbore (102) then flows back up to the surface in an annular space between the drill string (108) and the wellbore (102) with entrained cuttings. The mud with the cuttings is returned to the mud pit (132) to be circulated back again into the drill string (108). Typically, the cuttings are removed from the mud, and the mud is reconditioned as necessary, before pumping the mud again into the drill string (108). In one or more embodiments, the drilling operation may be controlled by the drilling control system (199).

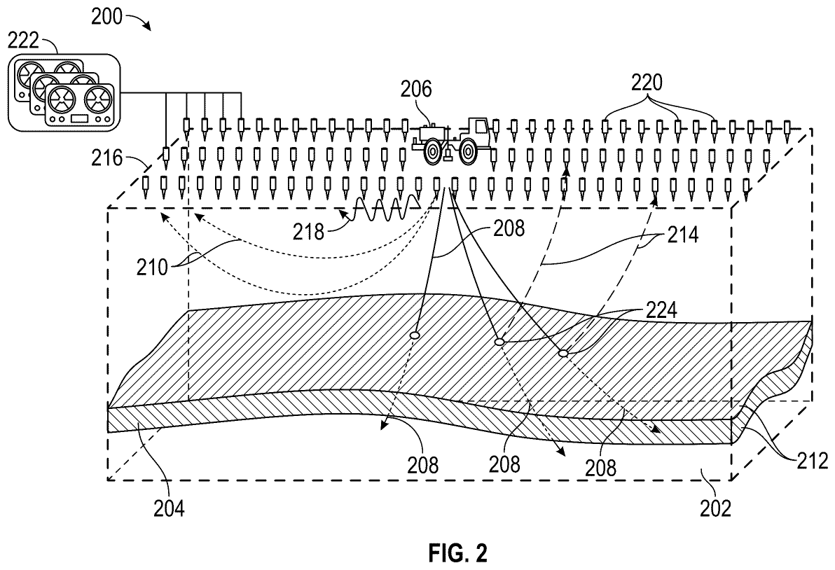

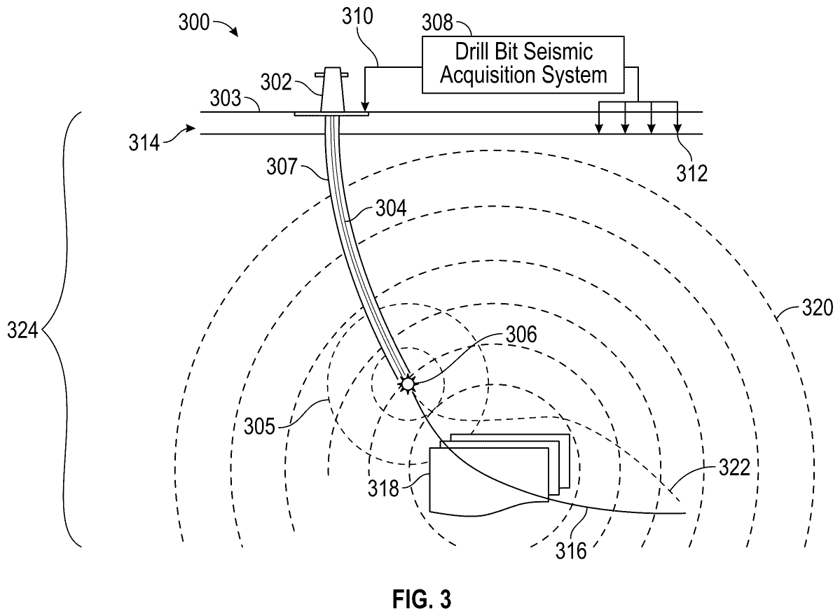

As noted, the well site (100) provides well logs either through measurement tools (114, 116) while drilling or by post-drilling surveys such as a wireline tool (not shown). Furthermore, data about the subsurface formations (104, 106) near a well site (100) may be obtained by analyzing the entrained cuttings, as a function to drilling depth, exiting the wellbore (102). In addition to data acquired at a well-site, other methods for collecting data and characterizing subsurface formations (104, 106) exist. For example, a seismic survey may be conducted. General concepts related to a seismic survey are discussed later in association with FIG. 2. Further, in some instances seismic data may be acquired using a seismic acquisition system while drilling using a process commonly referred to as “drill bit seismic.” A drilling system with drill bit seismic is depicted in FIG. 3 and described later in the instant disclosure.

Prior to the commencement of drilling, a wellbore plan may be generated. The wellbore plan may include a starting surface location of the wellbore (102), or a subsurface location within an existing wellbore (102), from which the wellbore (102) may be drilled. Further, the wellbore plan may include a terminal location that may intersect with a target zone (e.g., a hydrocarbon-bearing formation) and a planned wellbore path from the starting location to the terminal location. In other words, the wellbore path may intersect a previously located hydrocarbon reservoir.

Typically, the wellbore plan is generated based on best available information at the time of planning from subsurface models representing spatial property distributions, a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes.

The wellbore plan may include wellbore geometry information such as wellbore diameter and inclination angle. If casing is used, the wellbore plan may include casing type or casing depths. Furthermore, the wellbore plan may consider other engineering constraints such as the maximum wellbore curvature (“dog-log”) that the drill string (108) may tolerate and the maximum torque and drag values that the drilling system may tolerate.

A wellbore planning system (190) may be used to generate the wellbore plan. The wellbore planning system (190) may include one or more computer processors in communication with computer memory containing the subsurface, geophysical, and geomechanical models, information relating to drilling hazards, and the constraints imposed by the limitations of the drill string (108) and the drilling system. The wellbore planning system (190) may further include dedicated software to determine the planned wellbore path and associated drilling parameters, such as the planned wellbore diameter, the location of planned changes of the wellbore diameter, the planned depths at which casing will be inserted to support the wellbore (102) and to prevent formation fluids entering the wellbore, and the drilling mud weights (densities) and types that may be used during drilling the wellbore.

FIG. 2 shows a seismic acquisition system (200) configured for acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receivers (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some cases, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey. Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume, with coordinate axes (xᵣ, yᵣ, yₛ, yₛ, t).

To determine earth structure, including the presence of hydrocarbons, the seismic data set may be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll, ground roll, and multiples. A properly processed seismic data set may aid in decisions as to if and where to drill for hydrocarbons. Processing a seismic dataset to form a seismic image may include, but is not limited to: applying quality control methods to identify and correct for anomalous data (e.g., from a faulty seismic receiver (220)); application of a bandpass filter to remove low signal-to-noise (SNR) frequency bands; and normal moveout (NMO) correction.

FIG. 3 depicts a drilling system with drill bit seismic (300) in accordance with one or more embodiments. In such a system, a seismic survey may be conducted while drilling and the acquired seismic dataset may be processed in real time to optimize a wellbore path and update one or more geological models of the surrounding subsurface. It is noted that many components of the drilling system with drill bit seismic (300) are identical, or at least analogous to, components previously described with respect to the drilling system (100) of FIG. 1 and the seismic acquisition system (200) of FIG. 2 (e.g., drill bit, drillstring, wellbore, seismic receiver, etc.). For simplicity, like components are given their own numeric label in FIG. 3, however, distinct numeric labels do not imply a distinction between similarly listed and discussed components. The drilling system with drill bit seismic (300) may include a drilling rig (302) positioned on the surface of the earth (303). A drillstring (304) may extend from the drilling rig (302), through a wellbore (307) penetrating the subsurface (324), that may include a weathered layer (314) and a drill bit (306) may be disposed at the end of the drillstring (304).

In one or more embodiments, radiating seismic energy (306) may be produced by action of the drill bit (306) as it drills through the subsurface (324) rock to extend the length of the wellbore (307). Prior to drilling a wellbore, a well trajectory may be planned based upon the location of a drilling target, known or potential drill rig sites on the surface of the earth (303) and information about the subsurface (324). For example, a hydrocarbon reservoir may be targeted by the well trajectory. The wellbore trajectory may be planned using a well planning system (190, not shown in FIG. 3).

Information regarding the planned wellbore and well trajectory may be transferred to a drilling control system (199) described in FIG. 1. The drill bit (306) may be guided by an original well trajectory (316). However, in some cases the original well trajectory (316) may pass through one or more previously undetected geological features (318) (e.g., fractures). In one or more embodiments, radiating seismic energy (305) may interact with the previously undetected geological features (318) and create diffracted waves (320) that may propagate to the surface of the earth (303).

In one or more embodiments, a drill bit seismic acquisition system (308), operating similarly to the seismic acquisition system (200) in FIG. 2, may be positioned on the surface of the earth (303). The drill bit seismic acquisition system (308) may include a pilot sensor (310) disposed on the drilling rig (302) and in vibrational communication with the drillstring (304). More specifically, the pilot sensor (310) may be in acoustic contact with the drillstring (304) and able to detect vibrations generated by the drill bit (306) and propagating up the drillstring (304). The drill bit seismic acquisition system (308) may also include three-component seismic receivers (312). In one or more embodiments, the three-component seismic receivers (312) may be located in a weathered layer (314) beneath the surface of the earth (303) or, alternatively, attached to the surface of the earth (303).

The drill bit seismic acquisition system (308) may be used while drilling to detect and identify the previously undetected geological features (316) (e.g., fractures). In some instances, dependent on the characteristics of the until now detected geological features (318), it may be beneficial to avoid, with the drill bit (306) and/or the wellbore (307), these geological features. As such, the wellbore planning system (190) may be updated with the new information to generate an updated well trajectory (322) (planned wellbore path). For example, the wellbore plan may be updated based upon new data about the condition of the drilling equipment, and about the subterranean region through which the wellbore is drilled, such as the presence of previously undetected geological features (318).

As stated, embodiments disclosed herein relate to a noise attack system that adds and alters noise to synthetic seismic datasets in an adversarial manner to improve the generalization of machine-learned models for seismic processing tasks. In general, seismic processing tasks relate to the interpretation of seismic datasets and the subsequent construction of geological models, where a geological model is a 2D or 3D model, or digital representation, of the geology of a subsurface. Geological models may be used, among other things, to identify the location of a hydrocarbon reservoir, plan a wellbore path when drilling a well, and inform reservoir simulators for hydrocarbon production estimation and oil and gas field planning. Examples of seismic processing tasks may include fist break picking, denoising of seismic datasets, and fault detection. In general, one or more machine-learned models may be used to perform one or more seismic processing tasks. For example, two separate machine-learned models may be configured such that one model performs a first break picking task and the other model performs a denoising task. In some instances, a single machine-learned model may be configured to perform two or more seismic processing tasks through a process commonly known as “joint learning” using a “multi-target” model. In one or more embodiments, two or more machine-learned models may be configured to perform the same seismic processing task and their results may be ensembled (e.g., averaged together) to form a final result. In instances of ensembling, the ensembled machine-learned models differ in architecture and/or parameterization. The concepts of architecture and parameterization are discussed below.

Often, machine-learned models developed for seismic processing tasks exhibit reduced performance when used in practice (i.e., deployed, used in a production setting). Various reasons for the observed reduction in performance exist and may include: training of the machine-learned model using synthetically generated data, training the machine-learned model with data not representative of that being processed by the machine-learned model, and receiving data highly contaminated by noise. For example, in the case of drill bit seismic (as seen in FIG. 3), the ratio of signal to noise (STN) may precipitously decrease with increasing wellbore depth. Thus, seismic datasets acquired at increased wellbore depths may be contaminated with a relatively large amount of noise that negatively affects the performance of a machine-learned model in its seismic processing task(s).

As will be described, in accordance with one or more embodiments, the noise attack system may synthetically generate seismic datasets and intelligently add noise to the generated seismic datasets to “attack” a machine-learned model developed for a seismic processing task. The noise attack system may further interact with the machine-learned model to train or further tune the attacked machine-learned model to overcome—or have greater resilience to—the attacks, or the intelligently-curated noise. As such, the machine-learned model, after interaction with the noise attack algorithm, will have improved generalization capabilities.

Because the noise attack system described herein is to be used in coordination with one or more machine-learned models, a brief introduction to machine learning and other relevant concepts is provided herein. In particular, a cursory introduction to various machine-learned models such as a neural network (NN) and convolutional neural network (CNN) are provided as these models are often used as components—or may be adapted and/or built upon—to form more complex models such as generative-adversarial networks (GANs), Restormers, and Transformers (e.g., Swin Transformer). However, it is noted that many variations of neural networks, convolutional neural networks, and any other machine-learned model, exist. Therefore, one with ordinary skill in the art will recognize that any variations to the machine-learned models introduced herein may be employed with the noise attack system without departing from the scope of this disclosure. Further, it is emphasized that the following discussions of machine-learned models are basic summaries and should not be considered limiting.

Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” that further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a machine-learned model is referred to as selecting the model “architecture.” Once a machine-learned model type and hyperparameters have been selected, the machine-learned model is trained to perform a task. In some instances, hyperparameters of a model may be learned during a training process of the machine-learned model. The concept of training a machine-learned model is discussed in greater detail later in the instant disclosure. Once a machine-learned model is trained, it may be used in a production setting (also known as deployment of the machine-learned model).

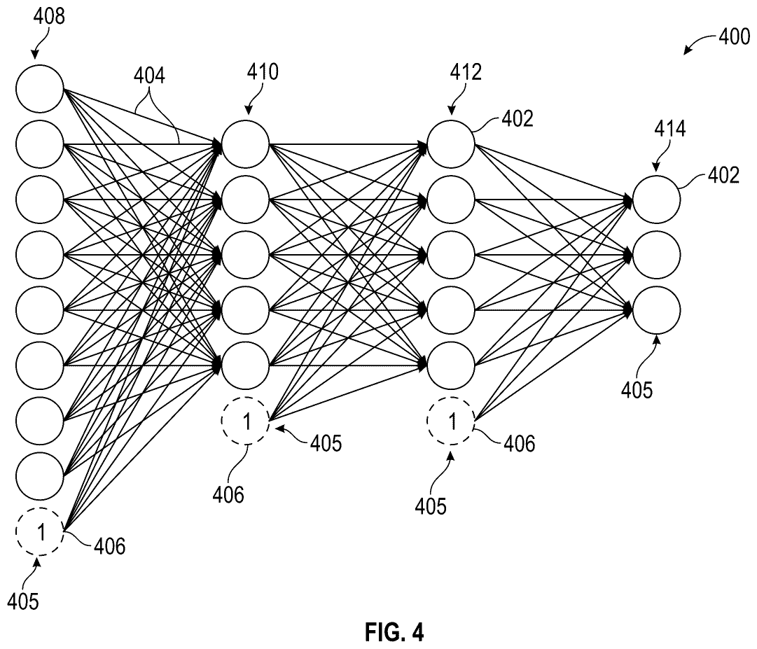

A diagram of a neural network is shown in FIG. 4. At a high level, a neural network (400) may be graphically depicted as being composed of nodes (402), where here any circle represents a node, and edges (404), shown here as directed lines. The nodes (402) may be grouped to form layers (405). FIG. 4 displays four layers (408, 410, 412, 414) of nodes (402) where the nodes (402) are grouped into columns, however, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be sparsely and residually connected. A neural network (400) will have at least two layers (405), where the first layer (408) is considered the “input layer” and the last layer (414) is the “output layer.” Any intermediate layer (410, 412) is usually described as a “hidden layer.” A neural network (400) may have zero or more hidden layers (410, 412) and a neural network (400) with at least one hidden layer (410, 412) may be described as a “deep” neural network or as a “deep learning method.” In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The edge numerical values, or even the edges (404) themselves, are often referred to as “weights” or “parameters.” While training a neural network (400), numerical values are assigned to each edge (404). Additionally, every node (402) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (402) and edges (404) and f is a user-defined function. Incoming nodes (402) are those that, when viewed as a graph (as in FIG. 4), have directed arrows that point to the node (402) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (402) in a neural network (400) may have a different associated activation function. Often, as a shorthand, activation functions are described by the function ƒ by which it is composed. That is, an activation function composed of a linear function ƒ may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), displayed in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Training data is provided to the neural network (400). Generally, training data consists of pairs of inputs and associated targets. The targets represent the “ground truth,” or the otherwise desired output, upon processing the inputs. During training, the neural network (400) processes at least one input from the training data and produces at least one output. Each neural network (400) output is compared to its associated input data target. The comparison of the neural network (400) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (400) output and the associated target. The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target over the training data. Thus, the loss function is used to guide changes made to the edge (404) values, typically through a process called “backpropagation.”

While a full review of the backpropagation process exceeds the scope of this disclosure, a brief summary is provided. Backpropagation consists of computing the gradient of the loss function over the edge (404) values. The gradient indicates the direction of change in the edge (404) values that results in the greatest change to the loss function. Because the gradient is local to the current edge (404) values, the edge (404) values are typically updated by a “step” in the direction indicated by the gradient. The step size is often referred to as the “learning rate” and need not remain fixed during the training process. Additionally, the step size and direction may be informed by previously seen edge (404) values or previously computed gradients. Such methods for determining the step direction are usually referred to as “momentum” based methods.

Once the edge (404) values have been updated, or altered from their initial values, through a backpropagation step, the neural network (400) will likely produce different outputs. Thus, the procedure of propagating at least one input through the neural network (400), comparing the neural network (400) output with the associated target with a loss function, computing the gradient of the loss function with respect to the edge (404) values, and updating the edge (404) values with a step guided by the gradient, is repeated until a termination criterion is reached. Common termination criteria are: reaching a fixed number of edge (404) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (404) values are no longer intended to be altered, the neural network (400) is said to be “trained.”

A CNN is similar to a neural network (400) in that it can technically be graphically represented by a series of edges (404) and nodes (402) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. A seismic dataset, which may be multi-dimensional, has such a structural relationship because each data element, or grid point, in the seismic dataset has a spatial-temporal location. Consequently, a CNN is an intuitive choice for processing seismic datasets.

A structural grouping, or group, of weights is herein referred to as a “filter.” The number of weights in a filter is typically much less than the number of inputs, where here the number of inputs refers to the number of data elements or grid points in a seismic dataset. In a CNN, the filters can be thought as “sliding” over, or convolving with, the inputs to form an intermediate output or intermediate representation of the inputs which still possesses a structural relationship. Like unto the neural network (400), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (400) to produce a final output. Note, that in this context, the neural network (400) is still considered part of the CNN. Like unto a neural network (400), a CNN is trained, after initialization of the filter weights, and the edge (404) values of the internal neural network (400), if present, with the backpropagation process in accordance with a loss function.

A common architecture for CNNs is the so-called “U-net.” The term U-net is derived because a CNN after this architecture is composed of an encoder branch and a decoder branch that, when depicted graphically, often form the shape of the letter “U.” Generally, in a U-net type CNN the encoder branch is composed of N encoder blocks and the decoder branch is composed of N decoder blocks, where N≥1. The value of N may be considered a hyperparameter that can be prescribed by user or learned (or tuned) during a training and validation procedure. Typically, each encoder block and each decoder block consist of a convolutional operation, followed by an activation function and the application of a pooling (i.e., downsampling) or an upsampling operation. Further, in a U-net type CNN each of the N encoder and decoder blocks may be said to form a pair. Intermediate data representations output by an encoder block may be passed to, and often concatenated with other data, an associated (i.e., paired) decoder block through a “skip” connection or “residual” connection.

Another type of machine-learned model is a transformer. A detailed description of a transformer exceeds the scope of this disclosure. However, in summary, a transformer may be said to be a deep neural network capable of learning context among data features. Generally, transformers act on sequential data (such as a sentence where the words form an ordered sequence). Transformers often determine or track the relative importance of features in input and output (or target) data through a mechanism known as “attention.” In some instances, attention mechanism may further be specified as “self-attention” and “cross-attention,” where self-attention determines the importance of features of a data set (e.g., input data, intermediate data) relative to other features of the data set. For example, if the data set is formatted as a vector with M elements, then self-attention quantifies a relationship between the M elements. In contrast, cross-attention determines the relative importance of features to each other between two data sets (e.g., an input vector and an output vector). Although transformers generally operate on sequential data composed of ordered elements, transformers do not process the elements of the data sequentially (such as in a recurrent neural network) and require an additional mechanism to capture the order, or relative positions, of data elements in a given sequence. Thus, transformers often use a positional encoder to describe the position of each data element in a sequence, where the positional encoder assigns a unique identifier to each position. A positional encoder may be used to describe a temporal relationship between data elements (i.e., time series) or between iterations of a data set when a data set is processed iteratively (i.e., representations of a data set at different iterations). While concepts such as attention and positional encoding were generally developed in the context of a transformer, they may be readily inserted into—and used with—other types of machine-learned models. An example of a machine-learned model based on a transformer is the Swin transformer. A Swin transformer is a recently proposed deep learning architecture that utilizes multi-scale windows and hierarchical self-attention mechanisms to improve model performance and is typically applied to computer vision tasks (e.g., object detection, image segmentation, etc). Another related machine-learned model is a restormer. Typically, a restormer is used for image restoration tasks and is based on a residual network with attention mechanisms to improve the quality of the restored image.

Another type of machine-learned model with some relevance to embodiments disclosed herein is a generative adversarial network (GAN). Again, like the transformer, a detailed description of a GAN exceeds the scope of this disclosure. However, in summary, a GAN is generally composed of two machine-learned models that interact cyclically and are configured to perform opposing tasks. The two component machine-learned models of a GAN are typically called a generator and a discriminator. In general, the task of the generator is to produce a data object (e.g., an image) such that the generated object is indiscernible from a “real,” or non-generated data object. The task of the discriminator is to determine if a given data object is real or if the given data object was produced by the generator. Thus, these tasks may be said to be in opposition (i.e., adverse or adversarial) because the generator is tasked to produce a data object that cannot be distinguished from a real data object by the discriminator, where the discriminator is specifically tasked to identify data objects generated by the generator. As with the machine-learned models previously described, the generator and discriminator of a GAN (each a machine-learned model in itself) are parameterized by a set of weights (or edge values) that must be learned during training.

The training process of a GAN possesses some unique characteristics. Training a GAN consists of determining the weights that minimize a given loss function, however, the loss function is typically split into two parts, namely, a generator loss and an adversarial loss. During training, the generator receives input-target pairs and seeks to minimize the generator loss. Typically, the generator is trained, guided by the generator loss, for a fixed number of iterations (e.g., fixed number of data examples, fixed number of data batches, fixed number of epochs, etc.) or until reaching a stopping criterion. Subsequently, the discriminator (904) is given an assortment of real data objects and some data objects generated with the generator. It is noted that the label, or target, of the data objects processed by the discriminator during training is known. The adversarial loss quantifies the accuracy of the discriminator when determining if a data object received by the discriminator is real or fake (i.e., produced by the generator). The adversarial loss is used to guide and update the weights of both the discriminator and the generator. In other words, guided by the adversarial loss, the weights of the generator are updated to produce a data object that cannot be distinguished from a real (or original) data object by the discriminator. Again, use of the adversarial loss to update the discriminator and the generator may be applied for a fixed number of iterations (e.g., fixed number of data examples, fixed number of data batches, fixed number of epochs, etc.) or until reaching a stopping criterion. In some instances, the process of training the generator and the generator and discriminator as guided by the generator loss and the adversarial loss, respectively, is repeated cyclically until the discriminator can no longer distinguish between real and fake data objects due to the realism of the data objects produced by the generator. Typically, once trained, the discriminator of a GAN is discarded and the generator is used to generate data objects with sufficient realism.

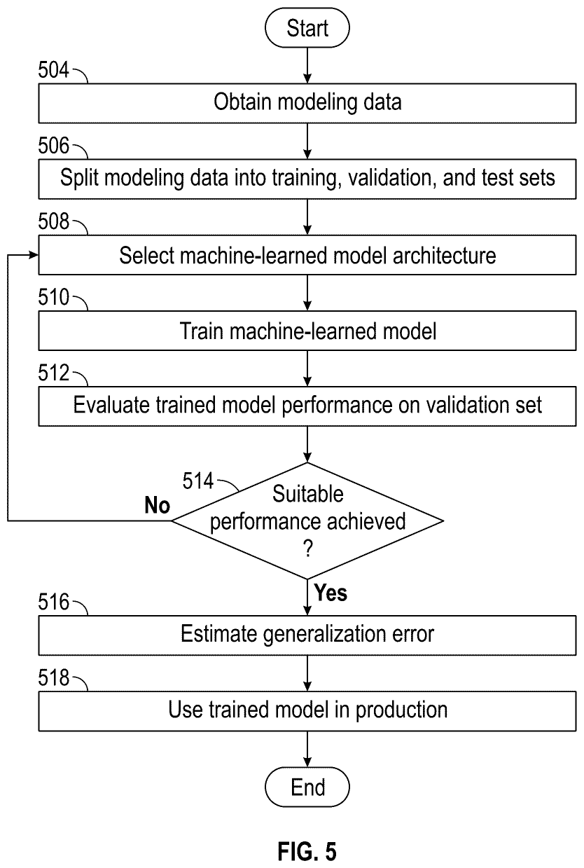

FIG. 5 depicts a general framework for training and evaluating a machine-learned model. Herein, when training a machine-learned model, the more general term “modeling data” will be adopted as opposed to training data to refer to data used for training, evaluating, and testing a machine-learned model. Further, use of the term modeling data prevents ambiguity when discussing various partitions of modeling data such as a training set, validation set, and test set, described below. In the context of FIG. 5, modeling data will be said to consist of pairs of inputs and associated targets. When a machine-learned model is trained using pairs of inputs and associated targets, that machine-learned model is typically categorized as a “supervised” machine-learned model or a supervised method.

To train a machine-learned model (e.g., a machine-learned model for a seismic processing task), modeling data must be provided. In accordance with one or more embodiments, modeling data may be collected from historical seismic datasets (e.g., seismic datasets acquired from previously conducted seismic surveys) with associated targets (e.g., labelled or annotated by a subject matter expert according to the seismic processing task). In one or more embodiments, modeling data is synthetically generated, for example, by artificially constructing a seismic dataset and associated target(s). In one or more embodiments, a seismic dataset is artificially constructed through perturbations of a “real” seismic dataset (e.g., a historical seismic dataset). In one or more embodiments, the perturbations are governed through a set of perturbation parameters, where the values of the perturbation parameters are determined based on the real seismic dataset. For example, in one or more embodiments, the values of the perturbation parameters are prescribed using statistical descriptions of the real seismic dataset. In this manner, the synthetic modeling data may be said to be informed by a prior, or prior information, derived from the real seismic dataset.

Keeping with FIG. 5, in Block 504, modeling data is obtained. As stated, the modeling data may be acquired from historical datasets, be synthetically generated, or may be a combination of real and synthetic data. In Block 506, the modeling data is split into a training set, validation set, and test set. In one or more embodiments, the validation and the test set are the same such that the modeling data is effectively split into a training set and a validation/testing set. In Block 508, given the machine-learned model type (e.g., CNN) an architecture (e.g., kernel size, U-net styled layers, etc.) is selected. In accordance with one or more embodiments, architecture selection is performed by cycling through a set of user-defined architectures for a given model type. In other embodiments, the architecture is selected based on the performance of previously evaluated models with their associated architectures, for example, using a Bayesian-based search. In Block 510, with an architecture selected, the machine-learned model is trained using the training set. During training, the machine-learned model is adjusted such that the output of the machine-learned model, upon receiving an input, is similar to the associated target. Once the machine-learned model is trained, in Block 512, the validation set is processed by the trained machine-learned model and its outputs are compared to the associated targets. Thus, the performance of the trained machine-learned model can be evaluated. Block 514 represents a decision. If the trained machine-learned model is found to have suitable performance as evaluated on the validation set, where the criterion for suitable performance is defined by a user, then the trained machine-learned model is accepted for use in a production (or deployed) setting. As such, in Block 518, the trained machine-learned model is used in production. However, before the machine-learned model is used in production a final indication of its performance can be acquired by estimating the generalization error of the trained machine-learned model, as shown in Block 516. The generalization error is estimated by evaluating the performance of the trained machine-learned model, after a suitable model has been found, on the test set. One with ordinary skill in the art will recognize that the training procedure depicted in FIG. 5 is general and that many adaptions can be made without departing from the scope of the present disclosure. For example, common training techniques, such as early stopping, adaptive or scheduled learning rates, and cross-validation may be used during training without departing from the scope of this disclosure.

To best explain the noise attack system, a conventional training process (e.g., following the steps of FIG. 5) for training a machine-learned model performing a seismic processing task, and its shortcomings, are described below. Further, various proposed improvements to a conventional training process (e.g., data augmentation) and the failures of these proposed improvements to increase the generalization performance and robustness of machine-learned models are discussed. Finally, the noise attack system is described along with concrete examples of its application to machine-learned models for the seismic processing tasks of first break picking and denoising of seismic datasets. These examples demonstrate the effectiveness of the noise attack system in improving the performance and generalization of machine-learned models for seismic processing tasks.

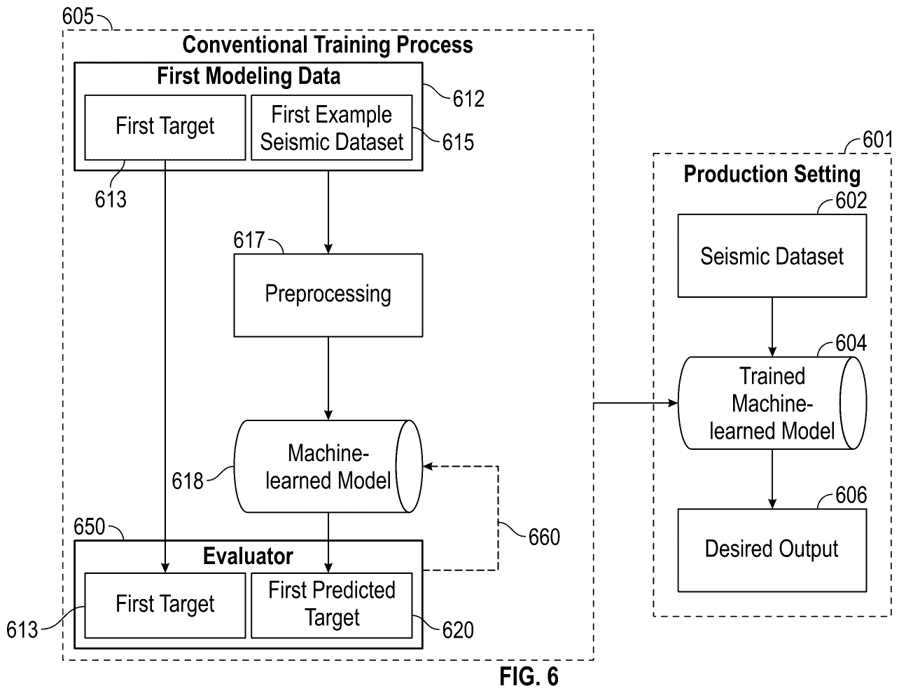

FIG. 6 depicts a high-level overview of the training process and use of a machine-learned model for performing a seismic processing task. As seen in FIG. 6, a trained machine-learned model (604) may be used in a production setting (601) to receive a seismic dataset (602) and produce a desired output (606) according to the seismic processing task that the trained machine-learned model (604) has been trained to perform. The desired output (606), for example, may be a denoised version of the received seismic dataset (602) if the trained machine-learned model (604) was trained for a denoising seismic processing task. Before the trained machine-learned model (604) can be used in a production setting (601), it must be trained. In general, the training procedure of FIG. 5 may be used to train the machine-learned model, including model type selection and choice of architecture. For clarity of later discussion, FIG. 6 also depicts a conventional training process of a machine-learned model. As seen in FIG. 6, in one or more embodiments, the conventional training process (605) includes obtaining first modeling data (612). The first modeling data (612) may consist of historical seismic datasets and associated targets (where the targets may be labelled or manually processed by a human operator), synthetically generated seismic datasets and associated targets, or a combination of historical and synthetically generated datasets. In FIG. 6, the modeling data is depicted as including a first example seismic dataset (615) with an associated first target (613). While the first example seismic dataset (615) and associated first target (613) are colloquially understood to be a singular instance of an input-target pair, one with ordinary skill in the art with recognize that this is done to simplify the figure and that, in practice, the first modeling data (612) may include many instances of input-target pairs. Further, during the conventional training process (605) any number of input-target pairs may be passed to and processed by the machine-learned model (618) being trained between updates of the weights (or parameters) of the machine-learned model. That is, in instances where the conventional training process (605) employs a backpropagation method to update the weights of the machine-learned model (618), input-target pairs may be passed and processed in batches, where batch size may be any number in the range [1, M] with M representing the total number of input-target pairs in the first modeling data (612).

Continuing with FIG. 6, when training a machine-learned model (618) according to a conventional training process (605), in one or more embodiments the first example seismic dataset (615) (or any of the “inputs” in the first modeling data (612)) may undergo preprocessing (617). Preprocessing may include well-known steps such as imputation and normalization. Preprocessing (617) may include the determination of one or more preprocessing parameters, such as the mean and standard deviation (or variance) of data features when performing normalization. In some instances, preprocessing parameters may be determined using a specified portion of the modeling data, such as a set of training data, when the modeling data is partitioned into more than one set of data. In such cases, the preprocessing steps may be applied to all remaining sets of data (e.g., validation set, test set) using the previously determined preprocessing parameters. In some instances, no preprocessing is performed.

As seen in FIG. 6, the proposed machine-learned model (618) receives the first example seismic dataset (615), which may have undergone preprocessing, and processes the first example seismic dataset (615) according to the current weights (or parameters) of the machine-learned model (618) to produce a first predicted target (620). The first predicted target (620) is compared to the first target (613), where the first target (613) acts as the “label” or ground truth associated with the first example seismic dataset (615), using an evaluator (650). In one or more embodiments, the evaluator (650) employs a loss function that quantifies at least one difference between the first predicted target (620) and the first target (613). Further, the evaluator (650) may transmit an update signal (e.g., first signal (660)) to the machine-learned model (618) in order to update the weights (or parameters) of the machine-learned model (618). The conventional training process (605) may be applied until a stopping criterion is reached. Upon termination of the conventional training process (605) the machine-learned model (618) may be considered trained and used as a trained machine-learned model (604) in a production setting (601).

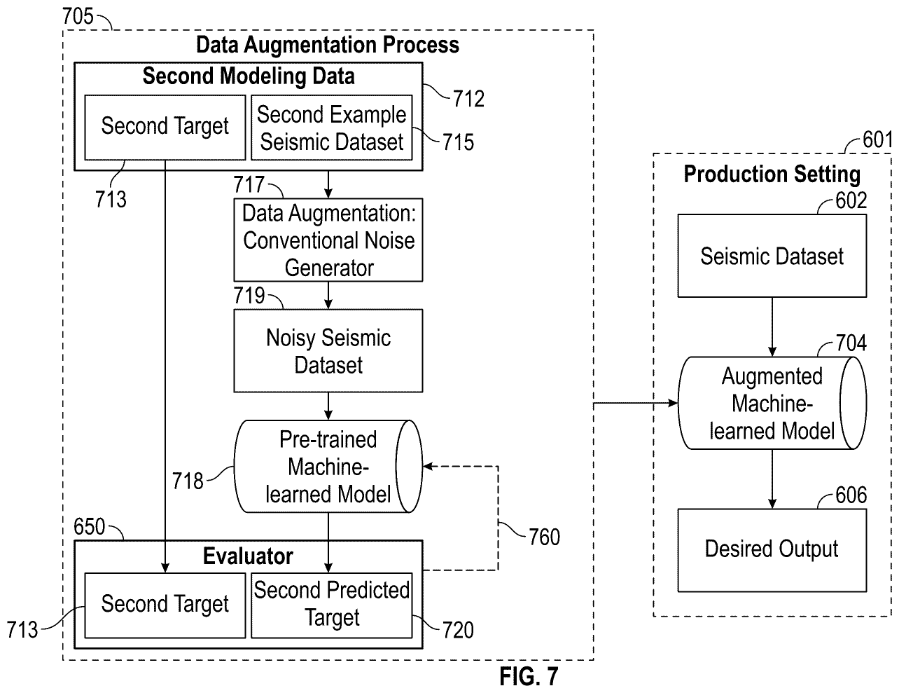

As previously stated, often, upon using a conventional training process (605), the performance of the trained machine-learned model (604) is poor or underwhelming when compared to performance estimates acquired during training. A proposed solution to improving the performance of the trained machine-learned model (604) may include further training the machine-learned model using a data augmentation technique. FIG. 7 depicts a data augmentation process (705). In the data augmentation process (705) depicted in FIG. 7, the data augmentation process (705) is applied to a “pre-trained” machine-learned model (718) such as the trained machine-learned model (604) developed using the conventional training process (604). In some instances, data augmentation can be applied during, or in coordination with, a conventional training process (604). That is, a pre-trained machine-learned model (718) is not a requirement for the data augmentation process (705). In FIG. 7, the output of the data augmentation process (705) is an augmented machine-learned model (704) that may be used in a production setting (601). The choice of the term “augmented” machine-learned model (704) is simply an artifact of this disclosure intended to distinguish between the trained or pre-trained machine-learned model (604, 718) in instances where the data augmentation process (705) is applied to a pre-trained machine-learned model (718). However, as stated, the data augmentation process (705) need not be separated from the conventional training process (604). In such instances, the output of the data augmentation process (705) may be considered a trained machine-learned model (604) without undue ambiguity.

As seen in FIG. 7, in one or more embodiments, the data augmentation process (705) includes obtaining second modeling data (712). The second modeling data (712) may consist of synthetically generated seismic datasets and associated targets. In FIG. 7, the modeling data is depicted as including a second example seismic dataset (715) with an associated second target (713). While the second example seismic dataset (715) and associated second target (713) are colloquially understood to be a singular instance of an input-target pair, one with ordinary skill in the art with recognize that this is done to simplify the figure and that, in practice, the second modeling data (712) may include many instances of input-target pairs. Further, during the data augmentation process (705) any number of input-target pairs may be passed to and processed by the pre-trained machine-learned model (718) being trained between updates of the weights (or parameters) of the pre-trained machine-learned model. That is, in instances where the data augmentation process (705) employs a backpropagation method to update the weights of the pre-trained machine-learned model (718), input-target pairs may be passed and processed in batches, where batch size may be any number in the range [1, N] with N representing the total number of input-target pairs in the second modeling data (712).

When augmenting the pre-trained machine-learned model (718) according to a data augmentation process (705), in one or more embodiments the second example seismic dataset (715) (or any of the “inputs” in the second modeling data (712)) may undergo preprocessing, however, for concision, a preprocessing step is not shown in FIG. 7

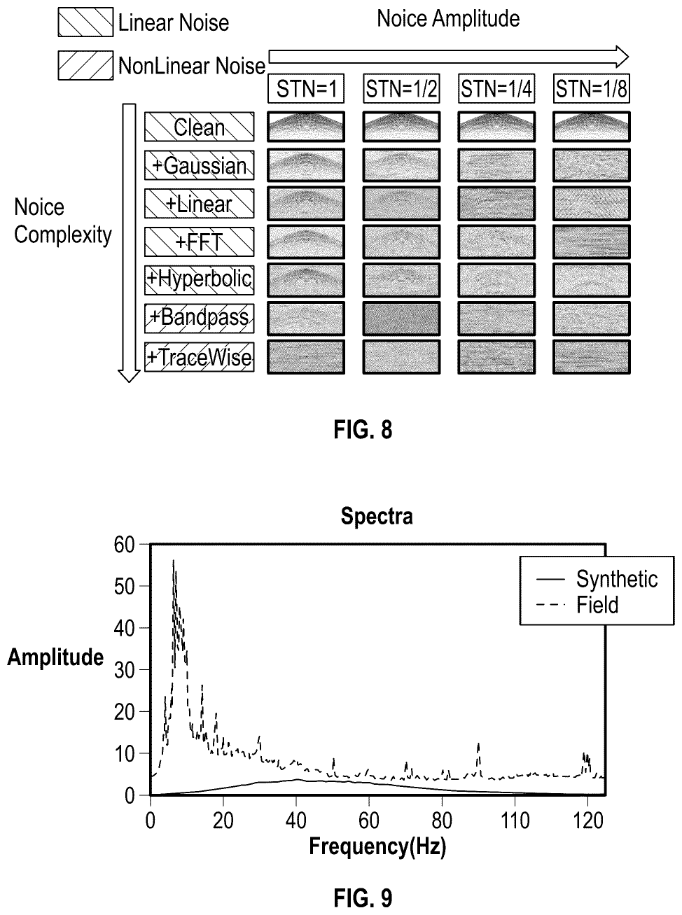

As seen in FIG. 7, in one or more embodiments, the second example seismic dataset (715) undergoes data augmentation (717) using a conventional noise generator. In general, the conventional noise generator randomly, or semi-randomly, generates noise to be added to the second example seismic dataset (715) as a means to augment, or perturb, the second example seismic dataset (715). In accordance with one or more embodiments, categories of noise may include but are not limited to: rain, speckle, bandpass, blurring, random, salt and pepper, colored, and linear. Noise may further be categorized based on the domain in which it is implemented (e.g., spatial-temporal, frequency, etc.) and the relative strength of the noise compared to the original signal (or seismic dataset to which the noise is added) as quantified by a signal-to-noise (STN) ratio. FIG. 8 depicts an example synthetic seismic dataset (the “clean” dataset) and the effect of the addition of various types of noise at a select few STN ratios. In FIG. 8, the types of noise are further organized according to a relative scale of complexity and whether the noise is considered to be “linear” or “non-linear” (e.g., non-linear noise may be noise produced by removing frequency components (high, low, or both) from the signal in a frequency domain). As seen in FIG. 8, based on the type and strength of noise added, patterns relating to features of the subsurface in the original synthetic seismic dataset (i.e., the clean dataset) may be obscured. These are linearly combined and weighted by a p value to control the signal-to-noise ratio. Each noise type has dedicated parameters that are randomly selected from a normal distribution to incorporate stochasticity in the model.

In general, “real” (or field-acquired) seismic datasets that are, or will be, processed by the trained machine-learned model in a production setting (601) are contaminated with more than one type of noise. Further, the STN ratio of seismic datasets seen in a production setting (601) may vary. For example, in drill bit seismic, the STN ratio may decrease with depth. As such, in one or more embodiments, the noise generated by the conventional noise generator is a linear and additive combination of various types of noise commonly associated with seismic datasets. In accordance with one or more embodiments, the conventional noise generator generates combination noise according to

$$combination noise = {\sum }_{k = 1}^{K} {α}_{k} {n}_{k} , \qquad EQ 2$$

where k indexes a type of noise (e.g., rain, bandpass, etc.), K indicates the total number of types of noise used by the conventional noise generator, nₖ represents generated noise of type k, and αₖ is a weighting factor that weights the relative importance of a noise type to the other types of noise considered. For example, by setting αₖ=0, then the k^{th} type of noise is effectively omitted from the combination noise. In one or more embodiments, αₖ=1∀kϵ[1, K]. In one or more embodiments, each generated type of noise may be randomly, or semi-randomly, produced upon each computational call (i.e., single use) of the conventional noise generator according to a set of associated noise parameters {p}ₖ. For example, for noise of a Gaussian noise type, the value added to each element, or grid point, of a seismic dataset may be randomly drawn from a normal distribution parametrized by a mean y and variance σ² (i.e., [symbol] (μ, σ²)). Thus, in this example, the set of noise parameters associated with Gaussian noise is {μ, σ²}.

In accordance with one or more embodiments, and as depicted in FIG. 7, a noisy seismic dataset (719) is formed by adding combination noise generated by the conventional noise generator to a given example seismic dataset from the second modeling data (712) (e.g., second example seismic dataset (715)). In accordance with one or more embodiments, the noisy seismic dataset (719) is formed according to

$$noisy seismic dataset = given seismic dataset + β * combination noise , \qquad EQ 3$$

where β is a parameter that controls the overall strength of the combination noise and thus the signal to noise (STN) ratio of the noisy seismic dataset (719).

Continuing with FIG. 7, the trained machine-learned model (718) receives the noisy seismic dataset (719) and processes the noisy seismic dataset (179) according to the current weights (or parameters) of the trained machine-learned model (718) to produce a second predicted target (720). The second predicted target (720) is compared to the second target (713), where the second target (713) acts as the “label” or ground truth associated with the second example seismic dataset (715), using the evaluator (650). Like stated with respect to FIG. 6, the evaluator (650) employs a loss function that quantifies at least one difference between the second predicted target (720) and the second target (713). Further, the evaluator (650) may transmit an update signal (e.g., second signal (760)) to the trained machine-learned model (718) in order to update the weights (or parameters) of the trained machine-learned model (718). The data augmentation process (705) may be applied until a stopping criterion is reached. Upon termination of the data augmentation process (705) the pre-trained machine-learned model (718) may be used in a production setting (601) and, in some instances, may be considered an augmented machine-learned model (704).

While the data augmentation process (705), in some instances, may improve the performance and generalizability of a machine-learned model for a seismic processing task, the data augmentation process (705) possesses several disadvantages. For example, intuitively, the robustness of a machine-learned model for a seismic processing task should improve if seismic datasets used in training and produced through a data augmentation process (705) mimic, or are representative of, seismic datasets (602) that are, or will be seen, in a production setting (601). For example, consider the case where the second modeling data (712) depicted in FIG. 7 is composed entirely of synthetically generated seismic datasets that are initially “clean” and only begin to demonstrate similarity to real seismic datasets (e.g., seismic dataset (602) in production setting (601)) with the addition of noise during a data augmentation process (717). In this case, it is generally desirable to configure the conventional noise generator to produce combination noise, that when added to synthetic seismic datasets, creates a noisy seismic dataset that mimics expected real seismic datasets (e.g., seismic dataset (602)). One method to compare the similarity of a noisy seismic dataset and a real, or expected, seismic dataset is to compare the frequency spectrums of the respective datasets. FIG. 9 depicts the frequency spectrum of a noise augmented seismic dataset (labelled “syn”) and the frequency spectrum of a real, or field acquired, seismic dataset (labelled “field”). As seen in FIG. 9, the frequency spectrums of the two datasets greatly varies. To improve the similarity of synthetic and noise augmented seismic dataset and real seismic datasets, a subject matter expert may need to configure the conventional noise generator. However, because the conventional noise generator is configured by many different parameters, such as the set of noise parameters for each noise type, the relative strength of each noise type (i.e., αₖ for k=1, . . . , K), and the value of ƒ (which may also be randomly selected according to a random variable configured with its own set of parameters), proper configuration of the conventional noise generator may prove tedious, if not impossible. Further, FIG. 9 only depicts the frequency spectrum of a single real seismic dataset. In instances where the trained or augmented machine-learned model is expected to be applied to seismic datasets collected over subsurfaces with diverse geological features and characteristics, multiple conventional noise generator configurations may need to be specified to produce synthetic and noise augmented seismic datasets that mimic (e.g., in terms of frequency spectrum) real and/or expected seismic datasets associated with geologically diverse subsurfaces. As such, configuration of the conventional noise generator may become unwieldly, severely complicated, computationally costly, and/or impossible.

To potentially overcome the disadvantages of the data augmentation process (705), one may propose integrating a second “learning process” into the training process of a machine-learned model for seismic processing tasks by allowing the combination noise (i.e., the noise added to an example seismic dataset during data augmentation) to be directly learned. That is, an initial noise profile may be updated based on a comparison of a predicted target from a machine-learned model and a given target. The initial noise profile may be the combination noise generated by a conventional noise generator. In such instances, the conventional noise generator need not be perfectly configured eliminating a major disadvantage of the data augmentation process (705) as previously discussed. The process of learning a noise profile, or adapting an initial noise profile, to allegedly improve the robustness of a machine-learned model (or pre-trained machine-learned model) is referred to herein as a general adversarial process (1005).

In some ways, the general adversarial process (1005) resembles the training process of a GAN. As previously described when introducing the general concepts of a GAN, a typical GAN is trained using a generator and a discriminator. Often, the task of the generator is to produce a realistic looking, but fake, data object and the task of the discriminator is to identify data objects produced by the generator (the fakes) while also given “real” data objects. Thus, the generator and the discriminator may be said to operate in an adverse manner. However, the intent of operating a generator and discriminator in an adversarial manner is to improve the performance of the generator. Similarly, in the general adversarial process (1005), a machine-learned model is trained (or re-trained) to perform a seismic processing task. In one or more embodiments, an adversarial attacker (1002) is configured to alter the noise profile of a given noisy seismic dataset used to train (or re-train) the machine-learned model. The adversarial attacker (1002) alters the noise profile in an attempt to reduce the performance of the machine-learned model when performing its seismic processing task. As such, the machine-learned model and the adversarial attacker (1002) may be said to operate in an adverse manner. The intent of using an adversarial attacker (1002) is to improve the performance and robustness of the machine-learned model. It is noted that the preceding discussion offering a comparison between a generic GAN and the general adversarial process (1005) described herein is only provided as an alternate viewpoint that may aid the understanding of an interested reader. One with ordinary skill in the art will recognize that there are apparent differences between a GAN and the general adversarial process (1005). Further, it is stated that no concrete similarity between a GAN and the general adversarial process (1005) is expressed, nor implied, herein, and that any comparison between a GAN and the general adversarial process (1005) is non-limiting.

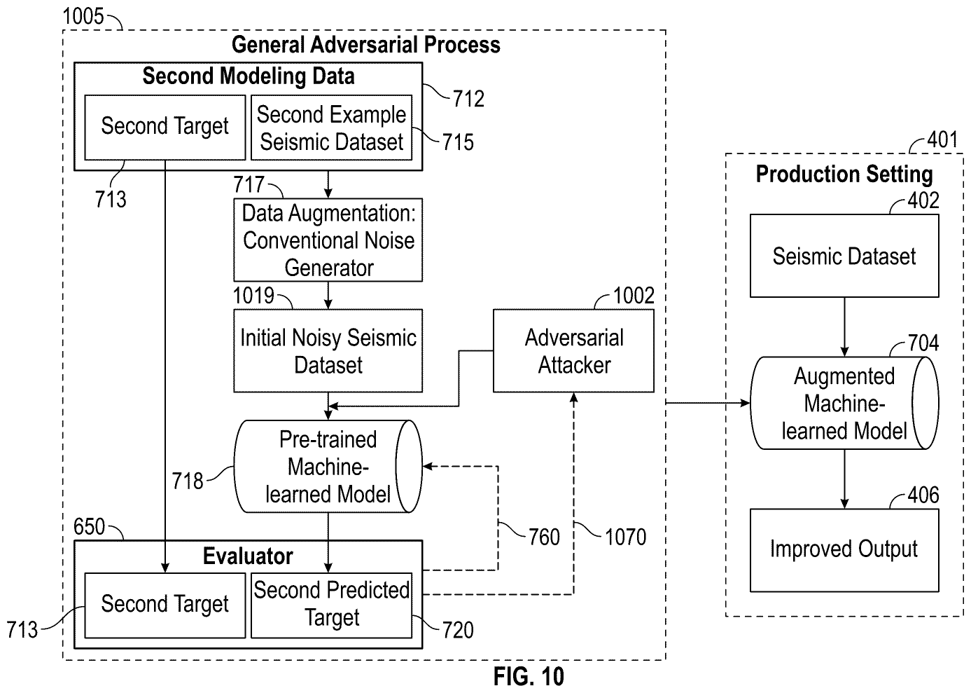

FIG. 10 depicts a high-level overview of the general adversarial process (1005) and use of a subsequently produced augmented machine-learned model (704) for performing a seismic processing task. As seen in FIG. 10, in one or more embodiments, the general adversarial process (1005) includes obtaining second modeling data (712). The second modeling data (712) may consist of synthetically generated seismic datasets and associated targets. In FIG. 10, the modeling data is depicted as including a second example seismic dataset (715) with an associated second target (713). While the second example seismic dataset (715) and associated second target (713) are colloquially understood to be a singular instance of an input-target pair, one with ordinary skill in the art with recognize that this is done to simplify the figure and that, in practice, the second modeling data (712) may include many instances of input-target pairs. Further, during the general adversarial process (1005) any number of input-target pairs may be passed to and processed by the pre-trained machine-learned model (718) being trained between updates of the weights (or parameters) of the pre-trained machine-learned model. That is, in instances where the general adversarial process (1005) employs a backpropagation method to update the weights of the pre-trained machine-learned model (718), input-target pairs may be passed and processed in batches, where batch size may be any number in the range [1, N] with N representing the total number of input-target pairs in the second modeling data (712).

In one or more embodiments, under the general adversarial process (1005), the second example seismic dataset (715) (or any of the “inputs” in the second modeling data (712)) may undergo preprocessing, however, for concision, a preprocessing step is not shown in FIG. 10.

As seen in FIG. 10, in one or more embodiments, the second example seismic dataset (715) undergoes data augmentation (717) using a conventional noise generator. A stated advantage of the general adversarial process (1005) is that the conventional noise generator, generally, does not need to be calibrated or configured to any expected real seismic dataset.

In accordance with one or more embodiments, and as depicted in FIG. 10, an initial noisy seismic dataset (1019) is formed by adding combination noise generated by the conventional noise generator to a given example seismic dataset from the second modeling data (712) (e.g., second example seismic dataset (715)). In accordance with one or more embodiments, the initial noisy seismic dataset (1019) is formed according to

$$initial noisy seismic dataset = given seismic dataset + β * combination noise , \qquad EQ 4$$

where β is a parameter that controls the overall strength of the combination noise and thus the signal to noise (STN) ratio of the initial noisy seismic dataset (1019).

Continuing with FIG. 10, the trained machine-learned model (718) receives the initial noisy seismic dataset (1019) and processes the initial noisy seismic dataset (179) according to the current weights (or parameters) of the trained machine-learned model (718) to produce a second predicted target (720). The second predicted target (720) is compared to the second target (713), where the second target (713) acts as the “label” or ground truth associated with the second example seismic dataset (715), using the evaluator (650). The evaluator (650) employs a loss function that quantifies at least one difference between the second predicted target (720) and the second target (713). Further, the evaluator (650) may transmit an update signal (e.g., second signal (760)) to the trained machine-learned model (718) in order to update the weights (or parameters) of the trained machine-learned model (718). Additionally, the evaluator (650) may provide an update signal (e.g., adversarial signal (1070)) to an adversarial attacker (1002) to guide updates to the initial noisy seismic dataset (1019). The general adversarial process (1005) may be applied until a stopping criterion is reached. Upon termination of the general adversarial process (1005) the pre-trained machine-learned model (718) may be used in a production setting (601) and, in some instances, may be considered an augmented machine-learned model (704).

In accordance with one or more embodiments, the general adversarial process (1002) may be formulated as a minimax problem. For example, representing a seismic dataset input to a machine-learned model (or, for example, the pre-trained machine-learned model (718) of FIG. 10) as x and using a function notation to represent the machine-learned model parameterized by a set of weights (or parameters) θ as h_{θ}, then, generally, the training process (or re-training) process for the machine-learned model (or pre-trained machine-learned model) consist of updating the weights θ to minimize a loss function l that quantifies a difference between the predicted target h_{θ}(x) and the given target y. Mathematically, this may be expressed as

$${min}_{θ} l ( {h}_{θ} ( x + δ ) , y ) , \qquad EQ 5$$

where δ represents the noise added to the input seismic dataset (e.g., initial noisy seismic dataset (1019).

In general, the above expression may be used by the evaluator (650) to determine an update signal to the weights of the machine-learned model, for example, the second signal (760). Similarly, the purpose of the adversarial attacker (1002) is to produce an update to the noise δ that maximizes the loss (according to the loss function l) when the noise is added to the input seismic dataset and the resulting output is compared to the given target. Mathematically, this may be expressed as

$${max}_{‖ δ ‖ \leq ϵ} l ( {h}_{θ} ( x + δ ) , y ) , \qquad EQ 6$$

where ε is a regularization parameter that constrains the amount of noise that may be added to input seismic dataset. As such, in one or more embodiments, ε (epsilon) may be used to define a STN ratio.

So, in combination, Equations 5 and 6 form a minimax problem that may be expressed as

$${min}_{θ} \frac{1}{\vert S \vert} {\sum }_{x , y ∈ S} {max}_{‖ δ ‖ \leq ϵ} l ( {h}_{θ} ( x + δ ) , y ) , \qquad EQ 7$$

where S represents a set of modeling data (e.g., second modeling data (712)), or input-target pairs x and y, and |S| indicates the total number of input-target pairs in the set S. There are various methods that may be employed to solve or otherwise optimize EQ 7 such as the fast gradient sign method (FGSM). A full discussion of minimax problems and the various methods that may be employed to solve or otherwise optimize such a problem exceeds the scope of this disclosure. One with ordinary skill in the art will recognize that any optimization method or solver may be used in the general adversarial process (1005) with respect to EQ 7. Further, in one or more embodiments, updates to the weights θ and updates to the added noise δ may be performed cyclically. For example, in one or more embodiments, the second signal (760) may be sent to the pre-trained machine-learned model (718) over a given number of iterations (say U iterations) followed by a transmission of the adversarial signal (1070) over a given number of iterations (say V iterations). Further, in instances where updates to the weights θ and the added noise δ, represented as the second signal (760) and the adversarial signal (1070), respectively, are performed using a gradient-based method, unique learning rates and gradient update rules (e.g., momentum parameters) may be used for the different updates. Depending on the implementation, such as the number of training instances considered in a batch (i.e., the batch size), and the solver or optimizer employed, additional algorithmic loops and/or sub-processes may be used in the general adversarial process (1005). For example, the summation in EQ 7 may be altered to represent any number of input-target pairs to be considered when formulating one or both of the update signals (i.e., second signal (760) and adversarial signal (1070)).

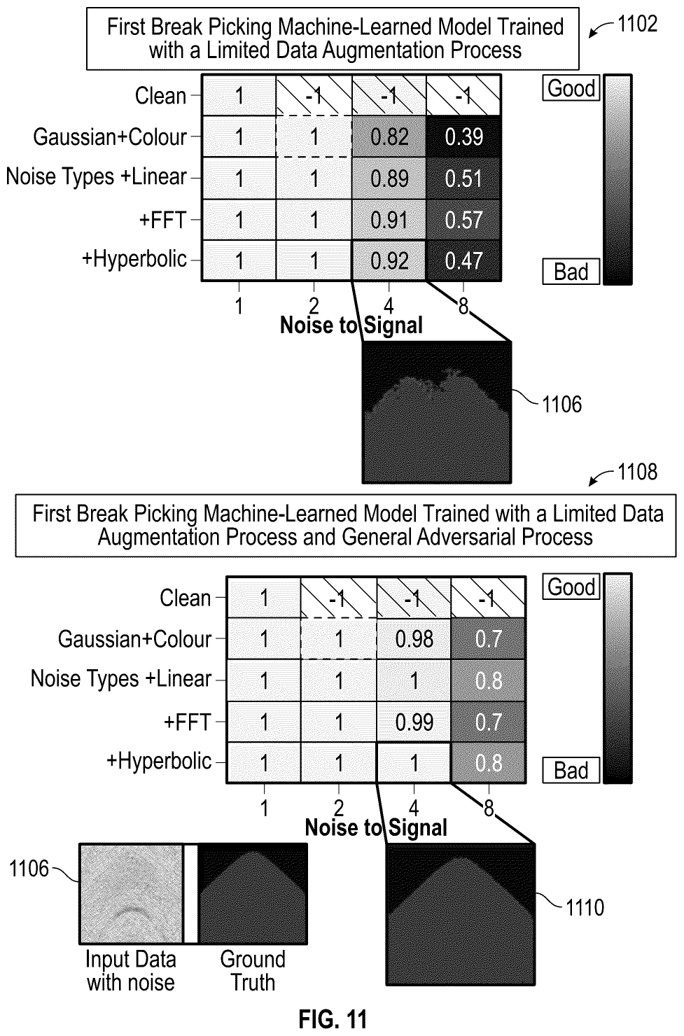

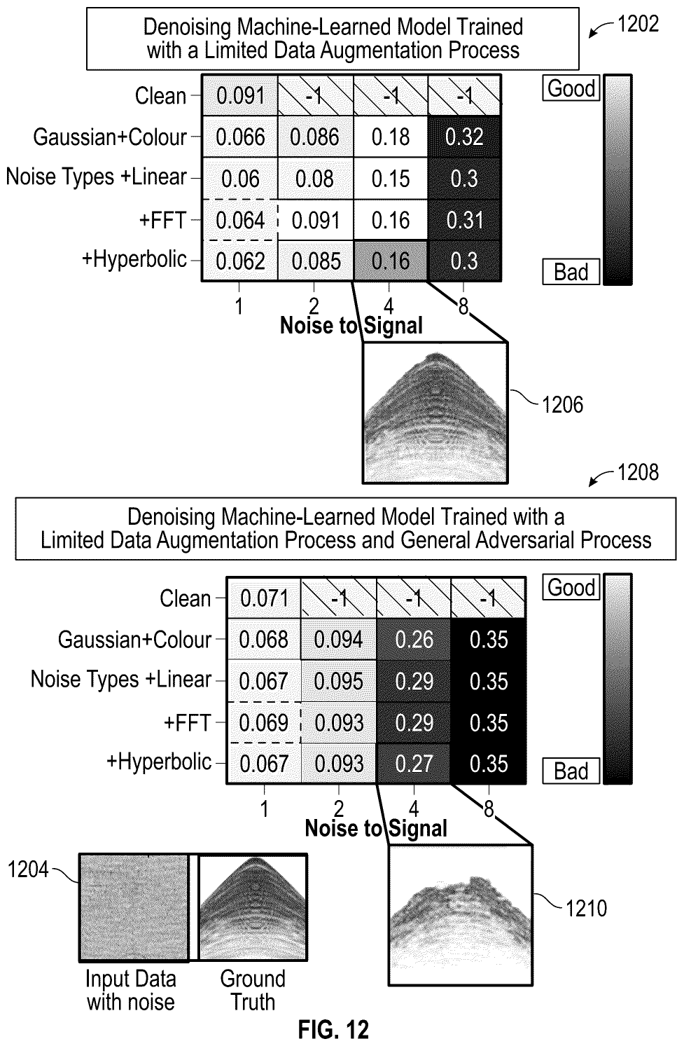

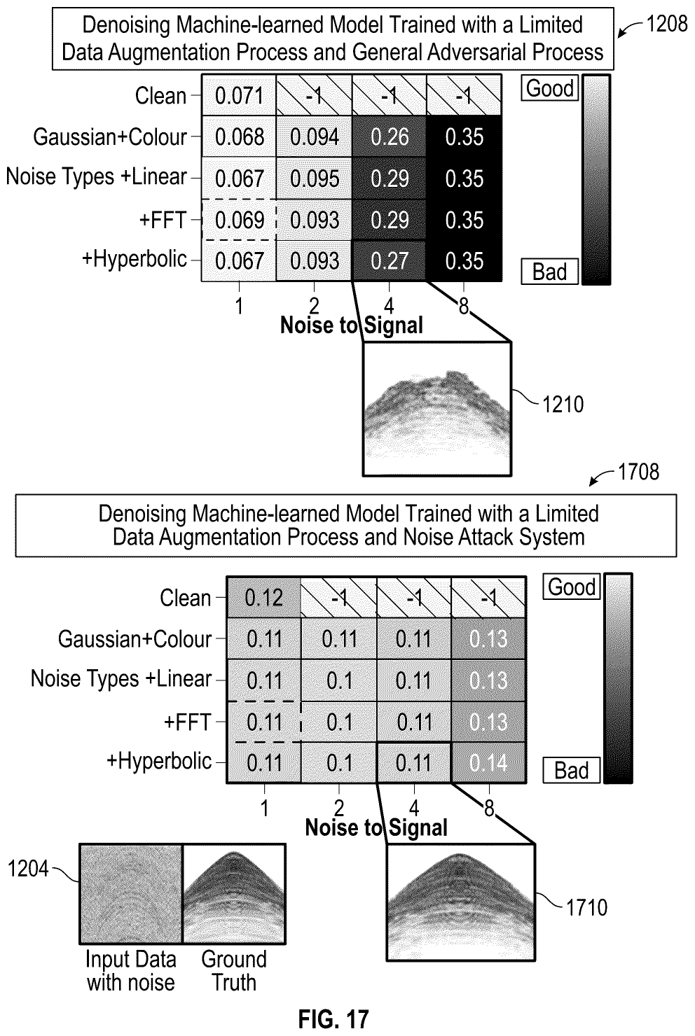

FIG. 11 depicts the results of a machine-learned model trained for the seismic processing task of first break picking using a limited data augmentation process and a limited data augmentation process combined with a general adversarial process applied to various synthetic seismic datasets with added noise categorized by noise type and relative strength. In both cases, a limited data augmentation process was used, where, herein, a “limited” data augmentation process means that when training the machine-learned model, a conventional noise generator was used to add noise to synthetic seismic datasets and the conventional noise generator was “limited to” only produce noise according to a specific regime of noise type and strength (i.e., STN ratio). For the models of FIG. 11, the conventional noise generator was configured to add Gaussian and color noise to any received synthetic datasets with a STN ratio of approximately 0.5. This noise regime is depicted in FIG. 11 using a dashed box. Thus, because during training, the conventional noise generator was constrained to only add noise according to a specified regime when other types of noise and strength, or combinations thereof, were available, the data augmentation process was said to be “limited.” Once trained, FIG. 11 depicts the tabulated mean intersection over union (mIoU) scores for the machine-learned models when applied to seismic datasets with noise added according to various noise types and strengths. It is noted that in FIG. 11, noise types are added in a cumulative manner from top-to-bottom according to the rows of the table that list noise types. That is, the “linear” regime includes Gaussian and color noise, the “FFT” regime (to be discussed below) includes Gaussian, color, and linear noise, etc. The same methodology applies to FIGS. 12 and 17. Thus, because the noise produced by the conventional noise generator was limited to a certain noise regime (i.e., a limited data augmentation process) and then the resulting trained machine-learned models were applied to seismic datasets combined with categorically different types of noise (or the inclusion of more types of noise) and noise strength, the tabulated mIoU scores represent the generalization and robustness of the trained machine-learned models for the first break picking task.

Specifically, FIG. 11 depicts a first table (1102) indicating the mIoU scores for a first break picking machine-learned model trained with a limited data augmentation process. As stated, the limited data augmentation process used a conventional noise generator configured to produce noise profiles from an addition of Gaussian noise and color noise where the STN ratio of resulting combination noise was approximately 0.5. Further, FIG. 11 depicts a first example input-target pair (1104). The first example input-target pair is composed of an example synthetic seismic dataset with added noise (i.e., input data with noise). The added noise was produced using a conventional noise generator configured to add hyperbolic noise, FFT noise, and linear noise with an overall STN ratio of 0.25. This noise regime is depicted in FIG. 11 using a solid box. The first example input-target pair (1104) also has an associated target (i.e., ground truth). The result of processing the input of the first example input-target pair (1104) with the first break picking machine-learned model trained with a limited data augmentation process is depicted in FIG. 11 as the first result (1106).

FIG. 11 also depicts a second table (1108) indicating the mIoU scores for a first break picking machine-learned model trained with a limited data augmentation process and general adversarial process. In this case, the same limited data augmentation process was applied to add noise to synthetic dataset while training (or re-training). That is, the limited data augmentation process used a conventional noise generator configured to produce noise profiles from an addition of Gaussian noise and color noise where the STN ratio of resulting combination noise was approximately 0.5. However, in this case, the initial noise profiles developed by the conventional noise generator were further altered and/or updated using a general adversarial process (e.g., see FIG. 10). Comparison of the tabulated mIoU scores for between the first table (1102) and the second table (1108) indicate that for the first break picking task, the performance of the machine-learned model trained (or re-trained) for this task generally improved over all categorizations of noise types and strengths. Further, the result of processing the input of the first example input-target pair (1104) with the first break picking machine-learned model trained with a limited data augmentation process and general adversarial process is depicted in FIG. 11 as the second result (1110). As seen, the second result (1110) better approximates the ground truth of the first example input-target pair (1104) than the first result (1106). The initial takeaway from FIG. 11 is that adoption of a general adversarial process (1005) improves the generalization and overall robustness of the machine-learned model. However, as will be shown in FIG. 12, this alleged improvement is not universal to all seismic processing tasks.

FIG. 12 depicts the results of a machine-learned model trained for the seismic processing task of denoising again using a limited data augmentation process and a limited data augmentation process combined with a general adversarial process applied to various synthetic seismic datasets with added noise categorized by noise type and relative strength. For the models of FIG. 12, the conventional noise generator was configured to add noise of types Gaussian, color, linear, and “FFT,” where FFT noise is added by altering a given seismic dataset in its frequency domain (e.g., application of a lowpass, highpass, or bandpass filter). FFT refers to the fast Fourier transform algorithm and simply indicates that a FFT noise is associated with a transformation to and from the frequency domain. As in FIG. 11, this noise regime is depicted in FIG. 12 using a dashed box around the FFT regime and it is again noted that this noise regime includes all above-listed noise types in FIG. 11 (i.e., Gaussian, color, and linear). Once trained, FIG. 12 depicts the tabulated root mean squared error (RMSE) scores for the machine-learned models when applied to seismic datasets with noise added according to various noise types and strengths. Thus, because the noise produced by the conventional noise generator was limited to a certain noise regime (i.e., a limited data augmentation process) and then the resulting trained machine-learned models were applied to seismic datasets combined with categorically different types of noise and noise strength, the tabulated RMSE scores represent the generalization and robustness of the trained machine-learned models for the denoising task.

Specifically, FIG. 12 depicts a third table (1202) indicating the RMSE scores for a denoising machine-learned model trained with a limited data augmentation process. As stated, the limited data augmentation process used a conventional noise generator configured to produce FFT noise with a resulting STN ratio of approximately 1.0. Further, FIG. 12 depicts a second example input-target pair (1204). The second example input-target pair is composed of an example synthetic seismic dataset with added noise (i.e., input data with noise). The added noise was produced using a conventional noise generator configured to add hyperbolic noise with a STN ratio of 0.25. This noise regime is depicted in FIG. 12 using a solid box. Again, this noise regime includes all noise types listed “above” in the figure according to the rows of the table. The second example input-target pair (1204) also has an associated target (i.e., ground truth). The result of processing the input of the second example input-target pair (1204) with the denoising machine-learned model trained with a limited data augmentation process is depicted in FIG. 12 as the third result (1206).

FIG. 12 also depicts a fourth table (1208) indicating the RMSE scores for a denoising machine-learned model trained with a limited data augmentation process and general adversarial process (or trained with a limited data augmentation process followed by a general adversarial process). In this case, the same limited data augmentation process was applied to add noise to synthetic dataset while training (or re-training). That is, the limited data augmentation process used a conventional noise generator configured to FFT noise with a STN ratio of approximately 1.0. However, in this case, the initial noise profiles developed by the conventional noise generator were further altered and/or updated using a general adversarial process (e.g., see FIG. 10). Comparison of the tabulated RMSE scores for between the third table (1202) and the fourth table (1208) indicate that for the denoising task, the performance of the machine-learned model trained (or re-trained) for this task generally worsened over all categorizations of noise types and strengths. Further, the result of processing the input of the second example input-target pair (1204) with the denoising machine-learned model trained with a limited data augmentation process and general adversarial process is depicted in FIG. 12 as the fourth result (1210). As seen, the third result (1206) better approximates the ground truth of the second example input-target pair (1204) than the fourth result (1210). Thus, FIG. 12 indicates that the generalization of the machine-learned model for the seismic processing task of denoising is reduced or harmed when a general adversarial process (1005) is applied.

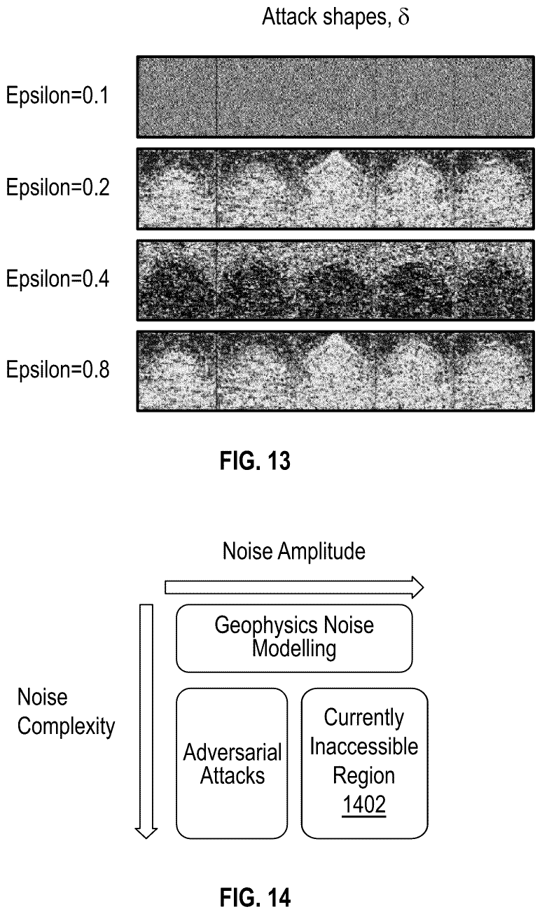

In combination, FIG. 11 and FIG. 12 demonstrate that the use of a general adversarial process (1005) does not guarantee an improvement in the generalizability of a machine-learned model (or pre-trained machine-learned model) in the context of seismic processing tasks. At first, this may seem counter intuitive. However, FIG. 13 provides some insight into why the general adversarial process (1005) may harm or otherwise reduce the performance and generalizability of a machine-learned model for seismic processing tasks. FIG. 13 depicts the noise δ to be added to various synthetic seismic datasets after alteration by an adversarial attacker (1002) at various noise constraint levels (i.e., epsilon (E) values). Recall that higher epsilon values allow for more pronounced and higher magnitude updates to the noise (see EQ 6). As seen in FIG. 13, for various synthetic seismic datasets, as the value of epsilon increases the noise δ that is added to the synthetic seismic datasets mimics (or perhaps more appropriately, inversely mimics) the structure of the initial given synthetic seismic dataset. Consequently, when the noise is added to the initial synthetic seismic dataset, the initial seismic dataset is ablated; and when applied to all inputs of modeling data (e.g., second modeling data (712)), the inputs become indistinguishable prohibiting the learning of the machine-learned model.

Returning to the concept that the intent of using an adversarial attacker (1002) is to improve the performance and robustness of the machine-learned model. In theory, this is done by forcing the machine-learned model to overcome, or learn in despite of, noise profiles tailored to reduce its performance. However, as seen in FIG. 13, the adversarial attacker (1002) may learn to reduce the performance of a machine-learned model by ablating the structure of the inputs used in training. In other words, the adversarial attacker (1002) may be said to overpower the machine-learned model by adopting a strategy that removes information (or structure) from inputs used to train (or re-train) the machine-learned model required for learning. In layman's terms, the adversarial attacker (1002) learns or memorizes the true data signature (synthetic seismic) and subtracts the noise. As such, the adversarial attacker (1002) may no longer be said to be learning; especially at increased noise levels (i.e., higher epsilon values).

FIG. 14 depicts a qualitative noise complexity vs. amplitude diagram. As depicted in FIG. 14, generally, noise profiles developed using the adversarial attacker (1002) of a general adversarial process (1005) are characterized by complex noise shapes but within a small range of amplitudes. In contrast, noise profiles developed using a conventional noise generator, which is restricted mainly to the categories of known or proposed geophysical noise types, are relatively simple but can be associated with high amplitudes. Thus, when generating noise to be added to a seismic dataset, whether by a conventional noise generator or an adversarial attacker, a region of high-complexity and high-amplitude noise is inaccessible (i.e., currently inaccessible region (1402)).

In accordance with one or more embodiments, the noise attack system described herein uses an “in-domain” adversarial attacker capable of generating noise profiles that may be characterized as both high-complexity and high-amplitude. Further, as will be demonstrated with various concrete examples, noise profiles produced using the in-domain adversarial attacker can achieve high epsilon values (high magnitude noise) without mimicking the structure of the underlying seismic datasets used for training. As such, the performance and generalizability of a machine-learned model trained (or re-trained) for a seismic processing task is improved using the noise attack system for any seismic processing task. The term “in-domain” is used because attacks from the in-domain adversarial attacker are performed in the frequency domain as opposed to the spatial-temporal domain. As will be described below, in one or more embodiments, a transform, such as a Fourier transform, is applied to an initial noisy seismic dataset to transform the dataset to the frequency domain. In one or more embodiments, a mask is applied to the frequency content such that some of the frequency content is occluded from, or cannot be altered by, the in-domain adversarial attacker. The in-domain adversarial attacker produces updates to the noise δ where the noise is added to the frequency content (as accessible according to the mask, if applied). The noise is added such that the resulting “attacked” frequency content, when inverse transformed back to the spatial-temporal domain, maximizes the loss (according to the loss function l) when compared to an associated target.

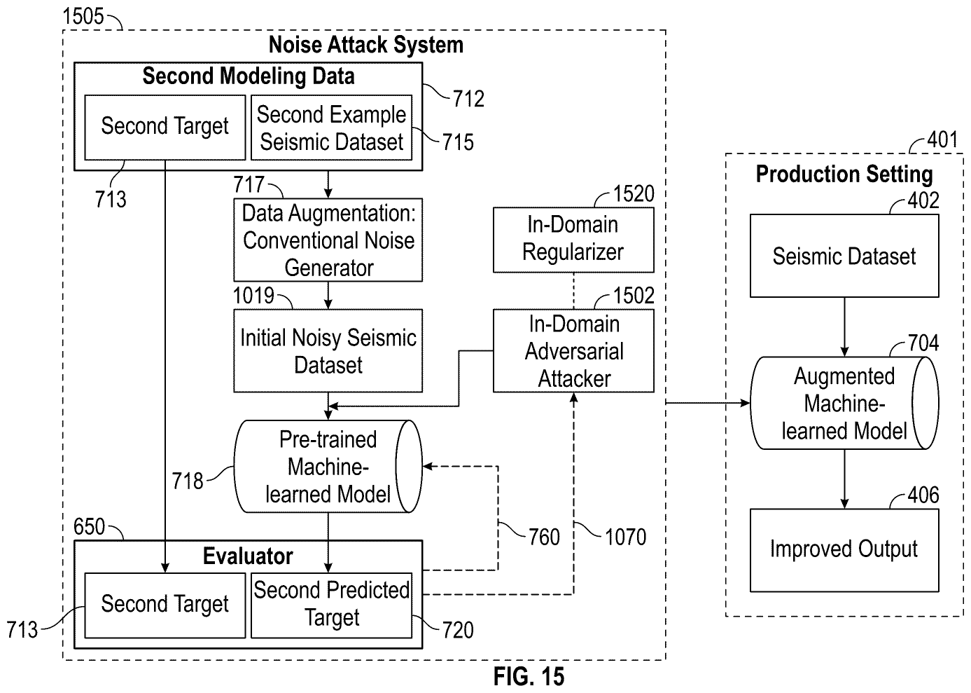

In accordance with one or more embodiments, FIG. 15 depicts a high-level overview of the noise attack system (1505) and use of a subsequently produced augmented machine-learned model (704) for performing a seismic processing task. As seen in FIG. 15, in one or more embodiments, the noise attack system (1505) includes obtaining second modeling data (712). The second modeling data (712) may consist of synthetically generated seismic datasets and associated targets. In FIG. 15, the modeling data is depicted as including a second example seismic dataset (715) with an associated second target (713). While the second example seismic dataset (715) and associated second target (713) are colloquially understood to be a singular instance of an input-target pair, one with ordinary skill in the art with recognize that this is done to simplify the figure and that, in practice, the second modeling data (712) may include many instances of input-target pairs. Further, during the processes of the noise attack system (1505) any number of input-target pairs may be passed to and processed by the pre-trained machine-learned model (718) being trained between updates of the weights (or parameters) of the pre-trained machine-learned model. That is, in instances where the noise attack system (1505) employs a backpropagation method to update the weights of the pre-trained machine-learned model (718), input-target pairs may be passed and processed in batches, where batch size may be any number in the range [1, N] with N representing the total number of input-target pairs in the second modeling data (712).

While FIG. 15 depicts the noise attack system (1505) as being applied to a pre-trained machine-learned model (718), it is emphasized that this is not a restriction. One with ordinary skill in the art will recognize that the noise attack system (1505) may be readily adapted for use during an initial training process, or the training of a machine-learned model (618), such as the process shown in FIG. 6. That is, the noise attack system (1505) need not be restricted to applications involving only previously trained, or pre-trained, machine-learned models.

In one or more embodiments, within the noise attack system (1505), the second example seismic dataset (715) (or any of the “inputs” in the second modeling data (712)) may undergo preprocessing, however, for concision, a preprocessing step is not shown in FIG. 15.

As seen in FIG. 15, in one or more embodiments, the second example seismic dataset (715) undergoes data augmentation (717) using a conventional noise generator. In general, the noise attack system (1505) shares the same advantage of the general adversarial process (1005) in that the conventional noise generator does not need to be calibrated or configured to seemingly approximate, once applied, to any expected real seismic dataset.

In accordance with one or more embodiments, and as depicted in FIG. 15, an initial noisy seismic dataset (1019) is formed by adding combination noise generated by the conventional noise generator to a given example seismic dataset from the second modeling data (712) (e.g., second example seismic dataset (715)).

Continuing with FIG. 15, the trained machine-learned model (718) receives the initial noisy seismic dataset (1019) and processes the initial noisy seismic dataset (179) according to the current weights (or parameters) of the trained machine-learned model (718) to produce a second predicted target (720). The second predicted target (720) is compared to the second target (713), where the second target (713) acts as the “label” or ground truth associated with the second example seismic dataset (715), using the evaluator (650). The evaluator (650) employs a loss function that quantifies at least one difference between the second predicted target (720) and the second target (713). Further, the evaluator (650) may transmit an update signal (e.g., second signal (760)) to the trained machine-learned model (718) in order to update the weights (or parameters) of the trained machine-learned model (718). Additionally, the evaluator (650) may provide an update signal (e.g., adversarial signal (1070)) to the in-domain adversarial attacker (1502) to guide updates to the initial noisy seismic dataset (1019). As seen in FIG. 15, the in-domain adversarial attacker (1502) is configured by an in-domain regularizer (1520). In accordance with one or more embodiments, the in-domain regularizer (1520) adds at least one degree of freedom to the in-domain adversarial attacker (1502) in such a way that noise profiles produced after updates from the in-domain adversarial attacker (1502) are not restricted in either noise complexity or amplitude. That is, in reference to FIG. 14, noise profiles produced using the in-domain adversarial attacker (1502) are able to access the region of high-complexity and high-amplitude noise. Further, as will be shown below, high-complexity noise profiles produced by the in-domain adversarial attacker (1502) do not learn the underlying structure of the input data. The processes of the noise attack system (1505) may be applied until a stopping criterion is reached. Upon termination of the processes of the noise attack system (1505) the pre-trained machine-learned model (718) may be used in a production setting (601) and, in some instances, may be considered an augmented machine-learned model (704).

In accordance with one or more embodiments, the in-domain regularizer (1520) implements a transformation of a given synthetic seismic dataset to the frequency domain. In one or more embodiments, the input seismic dataset, x, once transformed to the frequency domain may be referred to as frequency data (or frequency content), X. In one or more embodiments, some of the frequency data (the result of the transformation from the spatial-temporal domain to the frequency domain) is occluded from, or cannot be altered by, the in-domain adversarial attacker. That is, one or more embodiments, a mask is applied to the frequency content. In one or more embodiments, the mask is randomly applied. In other embodiments, the mask is randomly applied but is constrained such that the frequency content is masked (or unmasked) in one or more contiguous regions. In these embodiments, the in-domain adversarial attacker may directly alter, or perturb, the frequency content using a noise update, for example, X+δ. As noted, when using a mask, only regions or portions of the frequency data that are accessible, based on the mask, are altered by the noise update.

In other embodiments, frequency data of the same configuration (size and/or shape of the data object, frequency values, etc.) as the frequency data of an input seismic dataset is randomly generated. Herein, randomly generated frequency data is referenced as N. In accordance with one or more embodiments, the in-domain regularizer (1520) may apply a random mask to the randomly generated frequency data N. The mask determines which portions of the generated frequency data may be altered by the in-domain adversarial attacker. In some instances, the mask is constrained such that the frequency content is masked (or unmasked) in one or more contiguous regions. In one or more embodiments, the mask ablates, or otherwise sets portions of the generated frequency data N to a value of zero. In one or more embodiments, the in-domain adversarial attacker may directly alter, or perturb, the generated frequency content using a noise update, for example, N+δ. As noted, when using a mask, only regions or portions of the frequency data that are accessible, based on the mask, are altered by the noise update. And when the mask works to ablate, or otherwise set to zero, portions of the generated frequency data, this feature (of zero values) is maintained throughout any noise updates. The updated generated frequency data (i.e., N+δ) may be inverse transformed to the spatial-temporal domain. Generated frequency data inverse transformed to the spatial-temporal domain is herein referred to as n and may be considered a noise profile. Thus, if the input seismic dataset is represented as x, then the input seismic data may be updated with noise by simply adding the seismic dataset and the noise profile as x+n. It is emphasized that the noise profile may be generated in an iterative manner with more than one noise update applied to the generated frequency content, as required and/or configured by the noise attack system (1505). Further, the noise profile in the spatial-temporal domain may be checked or used by the noise attack system (1505) at any iteration using an inverse transform.

In other embodiments, the in-domain regularization is configured such that the in-domain adversarial attacker (1502) alters, via selective filtering, the frequency spectrum of the given synthetic seismic dataset to add and alter/update noise. For example, in one or more embodiments, the in-domain adversarial attacker (1502) forms a noise profile by determining regions of the frequency spectrum to apply a bandpass filter, where the regions may be updated and/or altered according to an adversarial signal (1070).

The application of the in-domain adversarial attacker (1502) in the frequency domain, as required by the in-domain regularizer (1520), acts to shield the structure of the given synthetic seismic dataset from the adversarial attack. The resulting noise profiles can be both high-amplitude and high-complexity without mimicking the structure of the initial synthetic seismic datasets. Further, a noise constraint, implemented as an epsilon value, can be provided through consideration of the noise profile (or updates to the noise profile) in the original, or spatial-temporal, domain.

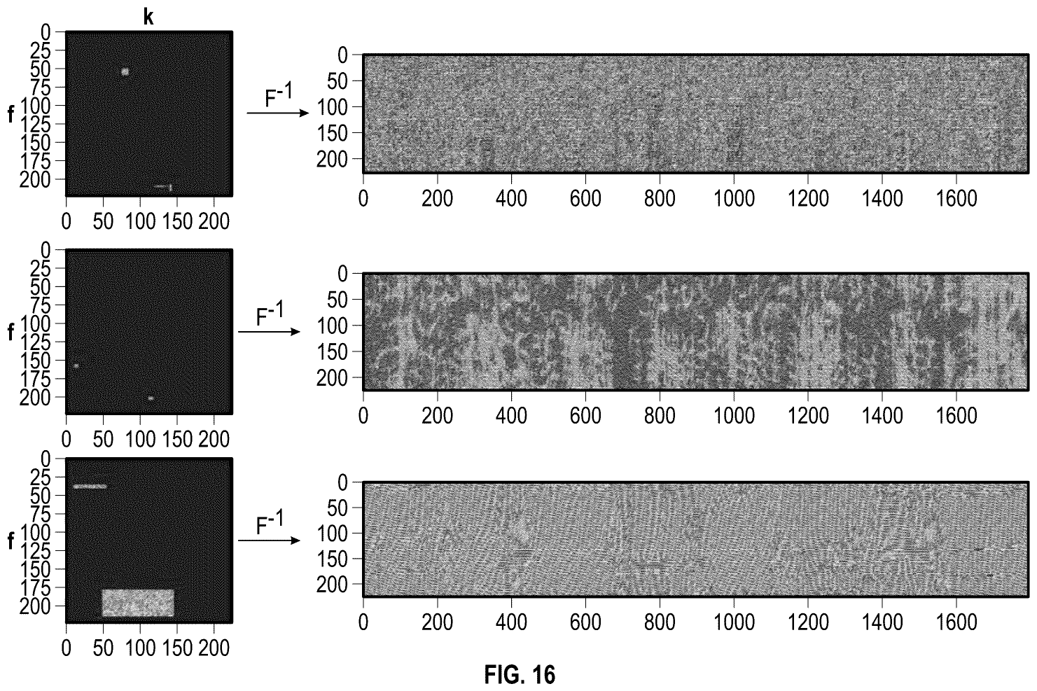

FIG. 16 depicts the frequency spectrum of three noise profiles developed using the in-domain adversarial attacker (1502) of the noise attack system (1505) in accordance with one or more embodiments. FIG. 16 also depicts the resulting noise profiles in the spatial-temporal domain after application of an inverse transform (F⁻¹). For the three examples of FIG. 15, the epsilon value is approximately 2.0. As seen, even at these relatively high epsilon values, the resulting noise profiles (visualized in the spatial-temporal domain) do not mimic the underlying structure of typical seismic datasets.

FIG. 17 depicts, again, the fourth table (1208) indicating the RMSE scores for a denoising machine-learned model trained with a limited data augmentation process and general adversarial process (or trained with a limited data augmentation process followed by a general adversarial process).

FIG. 17 also depicts a fifth table (1708) indicating the RMSE scores for a denoising machine-learned model trained with the same limited data augmentation process and the noise attack system (1505) (or trained with the limited data augmentation process followed by the application of the noise attack system (1505)). Comparison of the tabulated RMSE scores for between the fourth table (1208) and the fifth table (1708) indicate that for the denoising task, the performance of the machine-learned model trained (or re-trained) for this task generally performs better on unseen noise types when using the noise attack system (1505) as opposed to using the general adversarial process (1005) (over most noise types and strengths). Further, the result of processing the input of the second example input-target pair (1204) with the denoising machine-learned model trained with a limited data augmentation process and noise attack system (1505) is depicted in FIG. 17 as the fifth result (1710). As seen, the fifth result (1710) better approximates the ground truth of the second example input-target pair (1204) than the fourth result (1210).

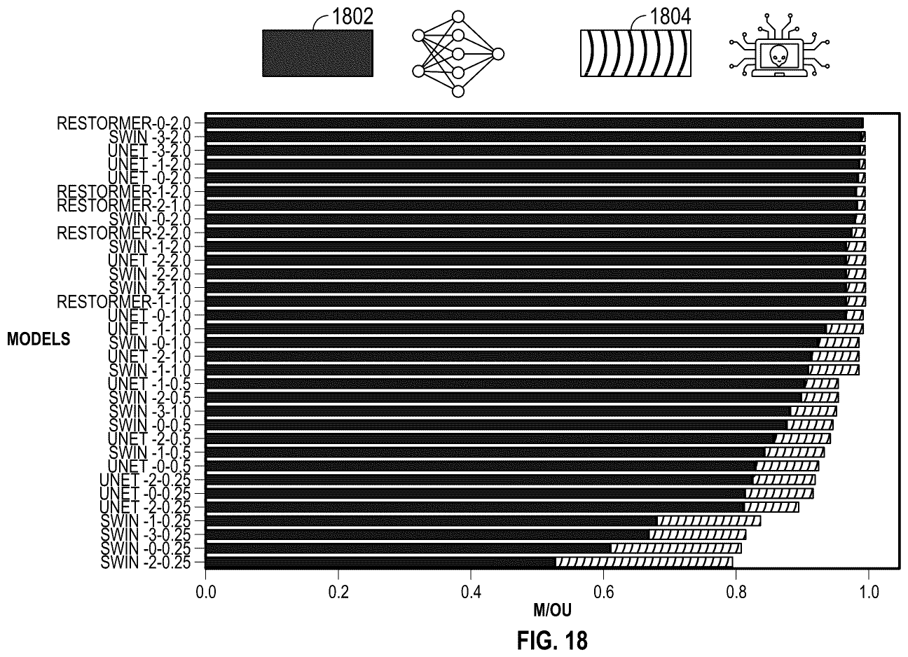

The data augmentation process (705) and noise attack system (1505) were applied to a large number of pre-trained machine-learned models of various machine-learned model types (e.g., restormer, U-net type CNN, etc.) with various architectures. FIG. 18 depicts the results, given as mIoU scores, for the top 40 performing model type and architecture combinations when these models were applied to the seismic processing task of first break picking. The legend of FIG. 18 denotes that a darker shading (1802) is used to indicate the mIoU scores of each machine-learned model after application of the data augmentation process (705). Likewise, lighter shading (1804) is used to indicate the mIoU scores of each machine-learned model after application of the noise attack system (1505). As seen, the machine-learned model performance is improved for all model types tested (where these model types are relatively unique to each other) and all considered architectures when the machine-learned models are developed for the seismic processing task of first break picking.

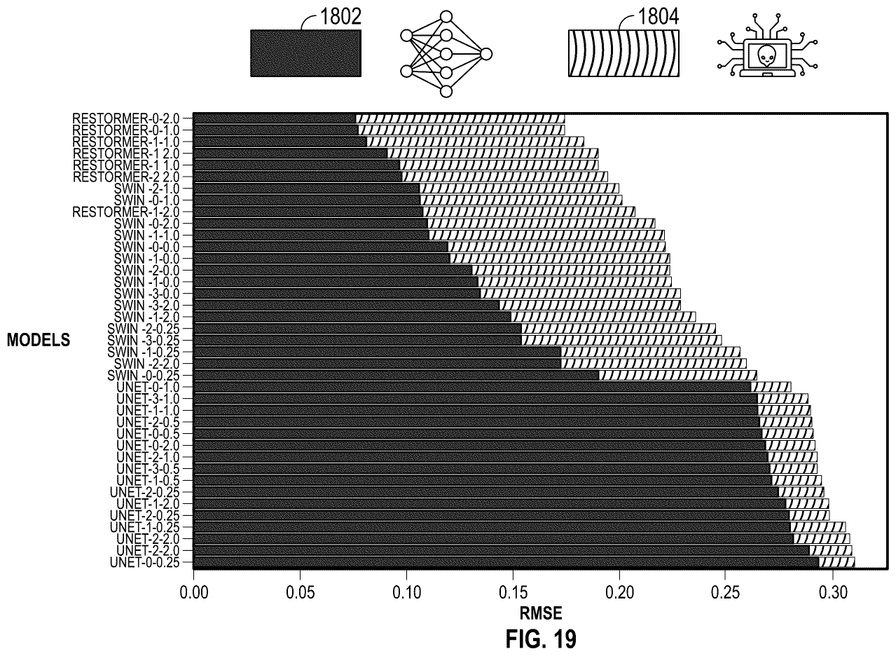

Similarly, the data augmentation process (705) and noise attack system (1505) were applied to a large number of pre-trained machine-learned models of various machine-learned model types (e.g., restormer, U-net type CNN, etc.) with various architectures for the seismic processing task of denoising. FIG. 19 depicts the results, given as RMSE values, for the top 40 performing model type and architecture combinations for the seismic processing task of denoising. The legend of FIG. 19 is identical to that of FIG. 18 where the darker shading (1802) is used to indicate the RMSE values of each machine-learned model after application of the data augmentation process (705) and the lighter shading (1804) is used to indicate RMSE values of each machine-learned model after application of the noise attack system (1505). As seen, the machine-learned model performance is improved for all model types tested (where these model types are relatively unique to each other) and all considered architectures when the machine-learned models are developed for the seismic processing task of denoising.

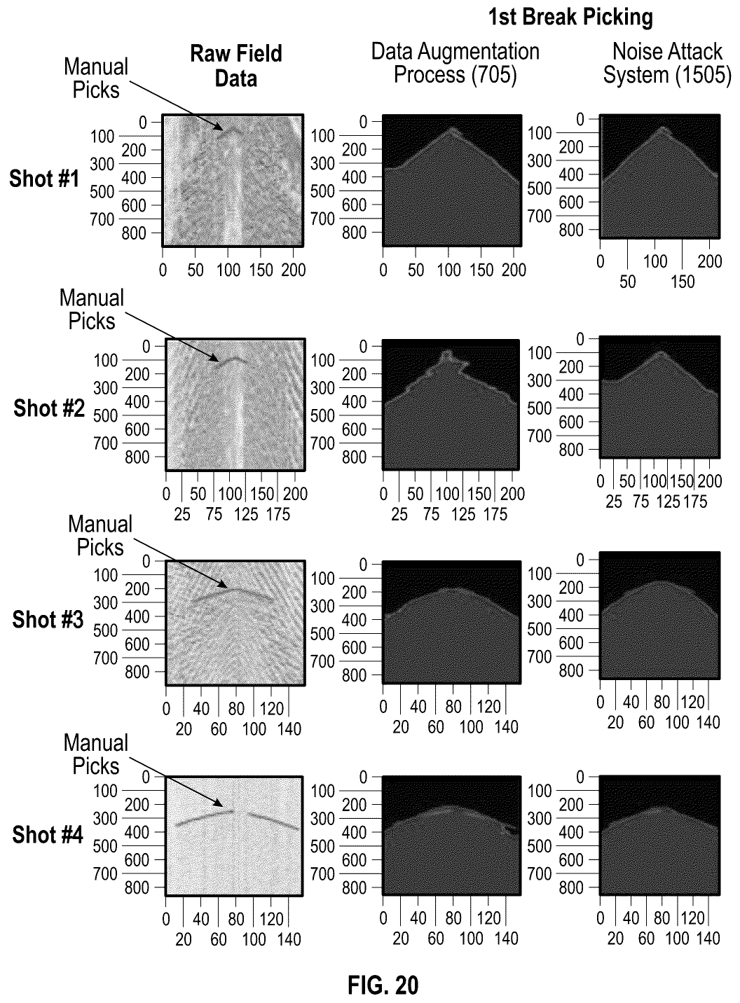

FIG. 20 depicts some results for the seismic processing task of first break picking using two different augmented machine-learned models; namely, a model augmented using a data augmentation process (705) and a model augmented according to the noise attack system (1505) described herein. Once trained and augmented, the machine-learned models were applied to actual field data (i.e., a production setting) where the first break picks were also manually identified by a subject matter expert (“manual picks” in FIG. 20). FIG. 20 depicts four shots from the field data at different depths (shots 1, 2, 3, and 4). As seen in FIG. 20, the machine-learned model trained and/or augmented only according to a data augmentation process (705) performs decently when visually inspected with the manual picks. Quantitative measures reveal that the machine-learned model produced using only the data augmentation process (705) provides an unstable pick with an error range between ±2-6 ms with respect to the manual picks provided by the subject matter expert. However, the machine-learned model produced using additional in-domain adversarial attacks according to the noise attack system (1505) has an accuracy of ±1 ms. Additionally, this machine-learned model is able to pick the first break at far offsets which was not possible using manual picking.

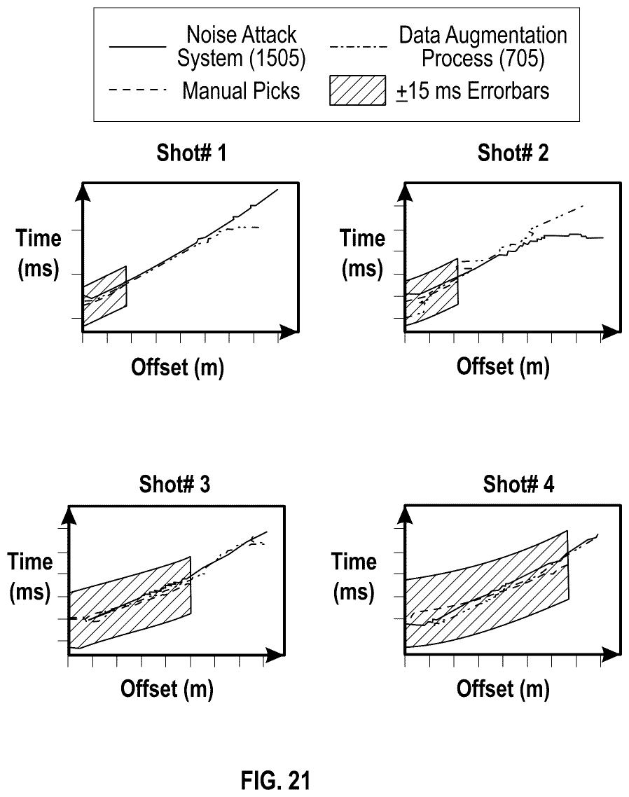

FIG. 21 depicts an alternative viewpoint that compares the first break picks identified by the subject matter expert, the first break picks determined using the machine-learned model trained and/or augmented using only the data augmentation process (705), and the first break picks determined by the machine-learned model trained and/or augmented using according to the noise attack system (1505) for the four shots of FIG. 20. The background error bars in FIG. 21 showcase a ±15 ms range.

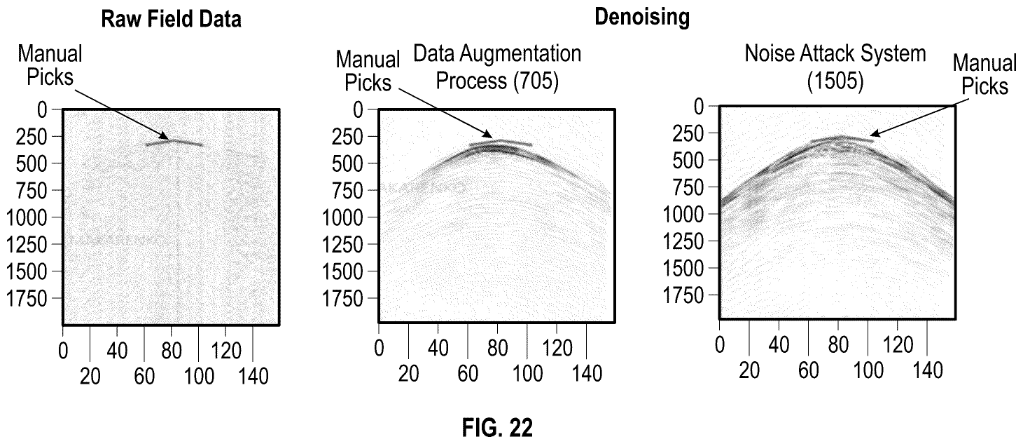

FIG. 22 depicts results for the seismic processing task of denoising using two different augmented machine-learned models; namely, a model augmented using a data augmentation process (705) and a model augmented according to the noise attack system (1505) described herein. Once trained and augmented, the machine-learned models were applied to actual field data (i.e., a production setting). As seen in FIG. 22, the machine-learned model produced using in-domain adversarial attacks according to the noise attack system (1505) provides better results with greater detailed waveforms in far offsets and in depth when compared to the denoised dataset resulting from the machine-learned model produced using only a data augmentation process (705). Further, in comparison, the near offset values of the denoised dataset output using the machine-learned model produced using the noise attack system (1505) are much closer to the manual picks.

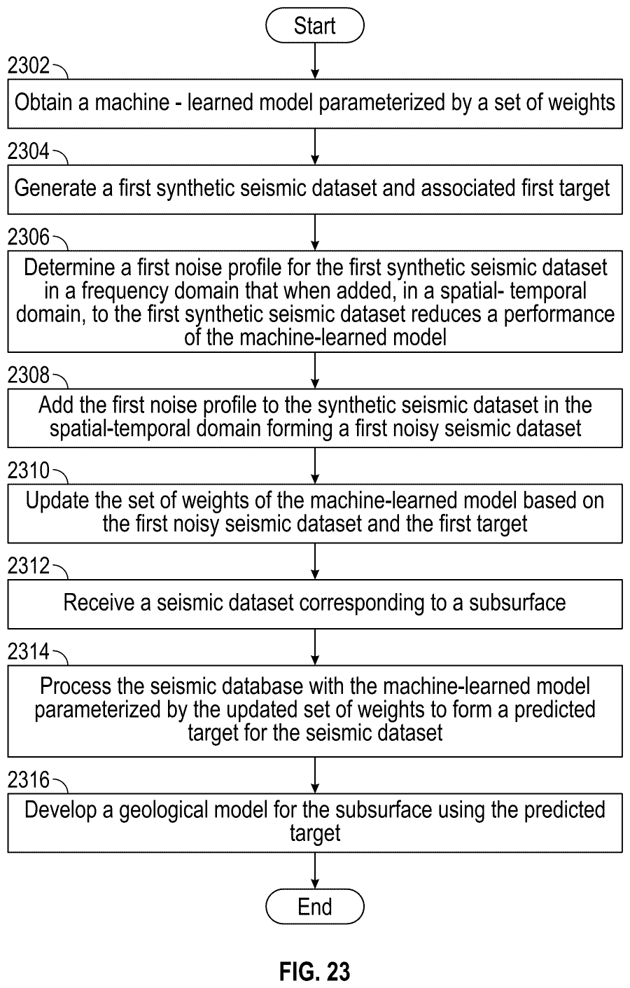

FIG. 23 outlines the general process for using and/or applying the noise attack system (1505) in accordance with one or more embodiments. In Block 2302 a machine-learned model parameterized by a set of weights is obtained. In one or more embodiments, the obtained machine-learned model is pre-trained (i.e., has be previously trained). In Block 2304, a first synthetic seismic dataset and associated first target are generated. In one or more embodiments, the first synthetic seismic dataset is generated by perturbing a real seismic dataset. In other embodiments, the first synthetic seismic dataset is determined using a proposed or basic velocity model of a subsurface and computationally modeling the propagation of a virtual seismic wavefield from a virtual seismic source to the locations of one or more virtual seismic receivers. In one or more embodiments, the first target represents the first break pick for the first synthetic seismic dataset. In other embodiments, the first target is simply the first synthetic seismic dataset before the addition of any noise. In general, the first target represents the ground truth output that is desired to be produced by the machine-learned model corresponding to a seismic processing task.

In Block 2306, a first noise profile for the first synthetic seismic dataset is determined. In general, the first noise profile is determined using the in-domain adversarial attacker configured according to an in-domain regularizer. In one or more embodiments, the in-domain regularizer restricts alterations to the first noise profile and/or first synthetic seismic dataset to a frequency domain. The first noise profile is determined such that when added to the synthetic seismic dataset, the performance of the machine-learned model, as measured by a performance metric suited for the seismic processing task (e.g., mIoU for first break picking) is reduced or decreased. In one or more embodiments, the first noise profile is determined iteratively through small alterations or updates applied to the first noise profile guided by an adversarial signal. In general, the adversarial signal specifies updates to the first noise profile based on a comparison of predicted synthetic target and the first target, where the predicted synthetic target is the output of the machine-learned model when processing the sum of the first synthetic seismic dataset and the first noise profile (or the current iteration of the first noise profile). It is noted that when adding the first noise profile (or any iteration or version of it) to the first synthetic seismic dataset, the addition is performed in a spatial-temporal domain.

In Block 2308, the first noise profile is added in the spatial-temporal domain to the first synthetic seismic dataset forming a first noisy seismic dataset. In Block 2310, the set of weights of the machine-learned model is updated based on a comparison of the predicted synthetic target and the first target, the predicted synthetic target is the output of the machine-learned model when processing the first noisy seismic dataset. In one or more embodiments, updates to the set of weights may be applied using one or more predicted synthetic targets produced using various iterations of the first noise profile added to the first synthetic seismic dataset. That is, in one or more embodiments, updates to the first noise profile and updates to the set of weights may be a cyclical and interactive process.

In Block 2312, a seismic dataset (i.e., a real or field-acquired, seismic dataset) is received. The seismic dataset corresponds to a subsurface. In one or more embodiments, the seismic dataset is obtained using a seismic survey acquisition system (e.g., a drill bit seismic acquisition system). In general, there is no known or immediately accessible target associated with the seismic dataset. Thus, the purpose of the machine-learned models is to perform a seismic processing task to determine, or predict, a target (or, in the current context, the result of a seismic processing task) for the seismic dataset. In Block 2314, the seismic dataset is processed using the machine-learned model parameterized by the updated set of weights to form a predicted target for the seismic dataset. In Block 2316, a geological model is developed based, at least in part, on the predicted target. In one or more embodiments, the geological model is used to identify the location of a hydrocarbon reservoir, plan a wellbore path when drilling a well, and/or inform reservoir simulators for hydrocarbon production estimation and oil and gas field planning.

Embodiments of noise attack system disclosed herein may provide the following advantages. First, it is noted that a common challenge in the oil and gas industry is that collected data (e.g., seismic datasets) is easily contaminated with noise. As a result, generally, significant effort goes into cleaning the collected data to prepare it for interpretation and analysis. In such situations, real time analysis of the collected data cannot be performed due to a bottleneck associated with the removal of noise. Embodiments of the noise attack system described herein allow for the real-time and automated denoising of collected data. In the context of collecting seismic data while drilling, the cleaned data can be used to provide real-time updates to a planned wellbore path and to generally guide a drill bit to its intended destination. Further, the clean collected data can be used with other geophysical techniques to invert the seismic data and collect elastic rock and fluid properties on site. By augmenting machine-learned models or pre-trained machine-learned models to be robust to noise perturbations in real-time using the noise attack system, these models can adapt to changing noise conditions and make accurate predictions on the fly.

Additionally, the noise attack system can be utilized to improve the performance and generalizability of any machine-learned models that are trained using solely synthetic data. In many applications, synthetic data is easily generated and labeled while real field data is scarce, contaminated, and difficult to label (often a tedious and time-consuming manual process). Unfortunately, despite the relative ease of generating synthetic data, many machine-learned models trained on synthetic seismic datasets fail to work successfully on field data, or real seismic datasets. This is because the modeling of noise is very challenging (e.g., the proper configuration of a conventional noise generator to mimic the frequency spectrum of real seismic data). However, the noise attack system automates the process of noise generation by learning noise profiles using the in-domain adversarial attacker. Use of the noise attack system allows for the production of robust machine-learned models for seismic processing tasks, with high performance on real seismic datasets, even when these models are trained using solely synthetic seismic datasets.

Further, the noise attack system reduces the configuration requirement for a conventional noise generator, where the configuration of a conventional noise generator is often time-consuming and requires domain expertise.

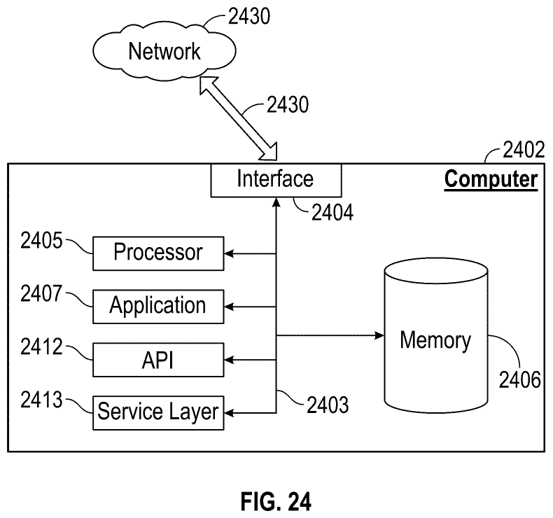

FIG. 24 further depicts a block diagram of a computer system (2402) used to provide computational functionalities associated with described algorithms, methods, functions, processes, flows, and procedures as described in this disclosure, according to one or more embodiments. The illustrated computer (2402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (2402) may include a computer that includes an input device, such as a keypad, keyboard, touch screen, or other device that can accept user information, and an output device that conveys information associated with the operation of the computer (2402), including digital data, visual, or audio information (or a combination of information), or a GUI.

The computer (2402) can serve in a role as a client, network component, a server, a database or other persistency, or any other component (or a combination of roles) of a computer system for performing the subject matter described in the instant disclosure. In some implementations, one or more components of the computer (2402) may be configured to operate within environments, including cloud-computing-based, local, global, or other environment (or a combination of environments).

At a high level, the computer (2402) is an electronic computing device operable to receive, transmit, process, store, or manage data and information associated with the described subject matter. According to some implementations, the computer (2402) may also include or be communicably coupled with an application server, e-mail server, web server, caching server, streaming data server, business intelligence (BI) server, or other server (or a combination of servers).

The computer (2402) can receive requests over network (2430) from a client application (for example, executing on another computer (2402) and responding to the received requests by processing the said requests in an appropriate software application. In addition, requests may also be sent to the computer (2402) from internal users (for example, from a command console or by other appropriate access method), external or third-parties, other automated applications, as well as any other appropriate entities, individuals, systems, or computers.

Each of the components of the computer (2402) can communicate using a system bus (2403). In some implementations, any or all of the components of the computer (2402), both hardware or software (or a combination of hardware and software), may interface with each other or the interface (2404) (or a combination of both) over the system bus (2403) using an application programming interface (API) (2412) or a service layer (2413) (or a combination of the API (2412) and service layer (2413). The API (2412) may include specifications for routines, data structures, and object classes. The API (2412) may be either computer-language independent or dependent and refer to a complete interface, a single function, or even a set of APIs. The service layer (2413) provides software services to the computer (2402) or other components (whether or not illustrated) that are communicably coupled to the computer (2402). The functionality of the computer (2402) may be accessible for all service consumers using this service layer. Software services, such as those provided by the service layer (2413), provide reusable, defined business functionalities through a defined interface. For example, the interface may be software written in JAVA, C++, or other suitable language providing data in extensible markup language (XML) format or another suitable format. While illustrated as an integrated component of the computer (2402), alternative implementations may illustrate the API (2412) or the service layer (2413) as stand-alone components in relation to other components of the computer (2402) or other components (whether or not illustrated) that are communicably coupled to the computer (2402). Moreover, any or all parts of the API (2412) or the service layer (2413) may be implemented as child or sub-modules of another software module, enterprise application, or hardware module without departing from the scope of this disclosure.

The computer (2402) includes an interface (2404). Although illustrated as a single interface (2404) in FIG. 24, two or more interfaces (2404) may be used according to particular needs, desires, or particular implementations of the computer (2402). The interface (2404) is used by the computer (2402) for communicating with other systems in a distributed environment that are connected to the network (2430). Generally, the interface (2404) includes logic encoded in software or hardware (or a combination of software and hardware) and operable to communicate with the network (2430). More specifically, the interface (2404) may include software supporting one or more communication protocols associated with communications such that the network (2430) or interface's hardware is operable to communicate physical signals within and outside of the illustrated computer (2402).

The computer (2402) includes at least one computer processor (2405). Although illustrated as a single computer processor (2405) in FIG. 24, two or more processors may be used according to particular needs, desires, or particular implementations of the computer (2402). Generally, the computer processor (2405) executes instructions and manipulates data to perform the operations of the computer (2402) and any algorithms, methods, functions, processes, flows, and procedures as described in the instant disclosure.

The computer (2402) also includes a memory (2406) that holds data for the computer (2402) or other components (or a combination of both) that can be connected to the network (2430). The memory may be a non-transitory computer readable medium. For example, memory (2406) can be a database storing data consistent with this disclosure. Although illustrated as a single memory (2406) in FIG. 24, two or more memories may be used according to particular needs, desires, or particular implementations of the computer (2402) and the described functionality. While memory (2406) is illustrated as an integral component of the computer (2402), in alternative implementations, memory (2406) can be external to the computer (2402).

The application (2407) is an algorithmic software engine providing functionality according to particular needs, desires, or particular implementations of the computer (2402), particularly with respect to functionality described in this disclosure. For example, application (2407) can serve as one or more components, modules, applications, etc. Further, although illustrated as a single application (2407), the application (2407) may be implemented as multiple applications (2407) on the computer (2402). In addition, although illustrated as integral to the computer (2402), in alternative implementations, the application (2407) can be external to the computer (2402).

There may be any number of computers (2402) associated with, or external to, a computer system containing computer (2402), wherein each computer (2402) communicates over network (2430). Further, the term “client,” “user,” and other appropriate terminology may be used interchangeably as appropriate without departing from the scope of this disclosure. Moreover, this disclosure contemplates that many users may use one computer (2402), or that one user may use multiple computers (2402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a machine-learned model parameterized by a set of weights;
generating a first synthetic seismic dataset and associated first target;
determining a first noise profile for the first synthetic seismic dataset in a frequency domain that when added, in a spatial-temporal domain, to the first synthetic seismic dataset reduces a performance of the machine-learned model;
adding the first noise profile to the first synthetic seismic dataset in the spatial-temporal domain forming a first noisy seismic dataset;
updating the set of weights of the machine-learned model based on the first noisy seismic dataset and the first target;
receiving a seismic dataset corresponding to a subsurface;
processing the seismic dataset with the machine-learned model parameterized by the updated set of weights to form a predicted target for the seismic dataset; and
developing a geological model for the subsurface using the predicted target.

2. The method of claim 1, further comprising planning a wellbore to penetrate a hydrocarbon reservoir based on the geological model, wherein the planned wellbore comprises a planned wellbore path.

3. The method of claim 2, further comprising a drilling the wellbore guided by the planned wellbore path.

4. The method of claim 1, further comprising:
generating a second synthetic seismic dataset and associated second target;
determining a second noise profile for the second synthetic seismic dataset in a frequency domain that when added, in a spatial-temporal domain, to the second synthetic seismic dataset reduces the performance of the machine-learned model;
adding the second noise profile to the second synthetic seismic dataset in the spatial-temporal domain forming a second noisy seismic dataset; and
updating the set of weights of the machine-learned model based on the second noisy seismic dataset and the second target.

5. The method of claim 1, wherein the first target represents first break picks for the first synthetic seismic dataset.

6. The method of claim 1, wherein the obtained machine-learned model is a previously trained or pre-trained machine-learned model.

7. The method of claim 1, wherein the machine-learned model is a U-net type convolutional neural network.

8. The method of claim 1, wherein determining the first noise profile comprises occluding frequency content of the first synthetic seismic dataset.

9. The method of claim 1, further comprising obtaining an epsilon value, wherein the epsilon value constrains a signal-to-noise ratio of the first noisy seismic dataset.

10. The method of claim 1, wherein the determination of the first noise profile is guided by an adversarial signal.

11. A system, comprising:
a machine-learned model parameterized by a set of weights;
a conventional noise generator that produces an initial noise profile;
an in-domain adversarial attacker configured by an in-domain regularizer that updates the initial noise profile to reduce a performance of the machine-learned model; and
a computer comprising one or more computer processors and a non-transitory computer-readable medium, the computer configured to:
generate a first synthetic seismic dataset and associated first target;
determine a first noise profile using the in-domain adversarial attacker by updating the initial noise profile;
add the first noise profile to the first synthetic seismic dataset in a spatial-temporal domain forming a first noisy seismic dataset;
update the set of weights of the machine-learned model based on the first noisy seismic dataset and the first target;
receive a seismic dataset corresponding to a subsurface;
process the seismic dataset with the machine-learned model parameterized by the updated set of weights to form a predicted target for the seismic dataset; and
develop a geological model for the subsurface using the predicted target.

12. The system of claim 11, further comprising a wellbore planning system to plan a wellbore to penetrate a hydrocarbon reservoir based on the geological model, wherein the planned wellbore comprises a planned wellbore path.

13. The system of claim 12, further comprising a drilling system configured to drill a wellbore guided by the planned wellbore path.

14. The system of claim 11, wherein the computer if further configured to:
generate a second synthetic seismic dataset and associated second target;
determine a second noise profile using the in-domain adversarial attacker by updating the initial noise profile;
add the second noise profile to the second synthetic seismic dataset in the spatial-temporal domain forming a second noisy seismic dataset; and
update the set of weights of the machine-learned model based on the second noisy seismic dataset and the second target;

15. The system of claim 11, wherein determining the first noise profile comprises occluding frequency content of the first synthetic seismic dataset as configured by the in-domain regularizer.

16. The system of claim 11, wherein the computer is further configured to obtain an epsilon value, wherein the epsilon value constrains a signal-to-noise ratio of the first noisy seismic dataset.

17. A non-transitory computer readable medium storing instructions executable by a computer processor, the instructions comprising functionality for:
obtaining a machine-learned model parameterized by a set of weights;
generating a first synthetic seismic dataset and associated first target;
determining a first noise profile for the first synthetic seismic dataset in a frequency domain that when added, in a spatial-temporal domain, to the first synthetic seismic dataset reduces a performance of the machine-learned model;
adding the first noise profile to the first synthetic seismic dataset in the spatial-temporal domain forming a first noisy seismic dataset;
updating the set of weights of the machine-learned model based on the first noisy seismic dataset and the first target;
receiving a seismic dataset corresponding to a subsurface;
processing the seismic dataset with the machine-learned model with an updated set of weights to form a predicted target for the seismic dataset; and
developing a geological model for the subsurface using the predicted target.

18. The non-transitory computer readable medium of claim 17, wherein the instructions further comprise functionality for planning a wellbore to penetrate a hydrocarbon reservoir based on the geological model, wherein the planned wellbore comprises a planned wellbore path.

19. The non-transitory computer readable medium of claim 17, wherein the instructions further comprise functionality for:
generating a second synthetic seismic dataset and associated second target;
determining a second noise profile for the second synthetic seismic dataset in a frequency domain that when added, in a spatial-temporal domain, to the second synthetic seismic dataset reduces the performance of the machine-learned model;
adding the second noise profile to the second synthetic seismic dataset in the spatial-temporal domain forming a second noisy seismic dataset; and
updating the set of weights of the machine-learned model based on the second noisy seismic dataset and the second target.

20. The non-transitory computer readable medium of claim 17, wherein determining the first noise profile comprises occluding frequency content of the first synthetic seismic dataset.
